(19) United States
(12) Patent Application Publication
(10) Pub. No.: US 2018/0336435 A1
(43) Pub. Date: Nov. 22, 2018

(54) APPARATUS AND METHOD FOR CLASSIFYING SUPERVISORY DATA FOR MACHINE LEARNING

(71) Applicant: CANON KABUSHIKI KAISHA, Tokyo (JP)

(72) Inventor: Koichi Takeuchi, Yokohama-shi (JP)

(21) Appl. No.: 15/977,971

(22) Filed: May 11, 2018

(30) Foreign Application Priority Data
May 17, 2017 (JP) 2017-098163

(51) Int. Cl. G06K 9/62; G06F 15/18; G06K 9/00; G06K 9/40

(52) U.S. Cl. CPC G06K 9/6264; G06F 15/18; G06K 9/40; G06K 9/6285; G06K 9/00369

(57) ABSTRACT

An information processing apparatus includes a receiving unit configured to receive designation of a category with respect to data contained in a plurality of pieces of data, a determination unit configured to determine a deviation which indicates a degree of deviance between the data contained in the plurality of pieces of data and a first category based on the data with respect to which the designation of the category is received by the receiving unit, and an identification unit configured to identify, from the plurality of pieces of data based on the determined deviation, data to be candidate data of a second category different from the first category.

### BACKGROUND

### Field

The present disclosure relates to an apparatus and method for classifying supervisory data for machine learning.

### Description of the Related Art

In recent years, machine learning such as deep learning has attracted attention. Machine learning is a technique/method that enables computers to perform the function of learning similar to the natural learning process of a person. As an example, the detection of whether images captured by a monitoring camera contain a suspicious individual, by using a computer, will be discussed below. To realize such detection, a definition of the suspicious individual being a detection target needs to be understood by the computer. A definition of a detection target can be based on a rule, pattern, etc. There are methods in which the definition of a detection target is designated in advance to a computer by a person. However, if the definition of the detection target is complicated or unknown, it is difficult for the person to designate the definition. Meanwhile, in a case of using machine learning, a computer learns the definition of a detection target based on supervisory data without requiring a person to designate the definition of the detection target. Thus, the computer can acquire the definition of a detection target even if the definition is complicated or unknown. However, since the results of machine learning depend on the quality of supervisory data used in the learning, it is important to generate high quality supervisory data.

Inaccurate classification of data contained in supervisory data can lead to unsuccessful learning. For example, if data of a category which is different from a category of a detection target is used as data of the detection target in learning, the definition of the detection target can be inaccurately learned. Therefore, accurate classification of data contained in supervisory data is important. However, supervisory data for machine learning is often large, and it requires time and work to check large-scale supervisory data.

The following are available techniques for efficient supervisory data classification.

Japanese Patent Application Laid-Open No. 2014-137284 discusses a technique that groups similar data and collectively checks and corrects supervisory data by group while checking representative examples. More specifically, a feature amount is extracted from data such as image data, and pieces of data having close feature amounts are grouped to display representative data of a group. If label data is set to representative data of a group, the label data is also passed on to other data belonging to the same group. In this way, since the label data can be set collectively by group to all the data that is part of the group, the amount of work is reduced compared to a process of checking every piece of data and setting label data for each piece of data separately.

Japanese Patent Application Laid-Open No. 2015-129988 discusses the following technique. Specifically, data that is likely to be noise data (hereinafter, “data suspected of containing noise”) is extracted based on a difference between a result of a classifier learned using supervisory data with preset initial label data and the initial label, and the label data is corrected. This technique uses errors in the classifier to be able to set label data only with respect to data suspected of containing noise, so that operation efficiency is likely to increase.

There are cases where a category to which each of a plurality of pieces of data belongs is unknown and it can be assumed that a minority of the data belong to a preset category, e.g., category such as “noise”, whereas the remaining majority of the data belong to another category, e.g., category such as “normal”. In such cases, if candidates for the data of the preset category are identified from the plurality of pieces of data and the classification operation is performed only with respect to the identified data, all the remaining data can be assumed to be the data of the other category. Thus, the classification operation efficiency is expected to increase. For this reason, identification of candidates for data of a present category from a plurality of pieces of data has been demanded.

However, the above-described techniques are not capable of identifying candidates for data of a present category from a plurality of pieces of data if the initial value of a category of each of the plurality of pieces of data is unknown.

### SUMMARY

According to various embodiments of the present disclosure, an information processing apparatus includes a receiving unit configured to receive designation of a category with respect to data contained in a plurality of pieces of data, a determination unit configured to determine a deviation which indicates a degree of deviance between the data contained in the plurality of pieces of data and a first category based on the data with respect to which the designation of the category is received by the receiving unit, and an identification unit configured to identify, from the plurality of pieces of data based on the determined deviation, data to be candidate data of a second category different from the first category.

Further features will become apparent from the following description of exemplary embodiments with reference to the attached drawings.

### BRIEF DESCRIPTION OF THE DRAWINGS

FIG. 1 illustrates an example of the system configuration of an information processing system according to one embodiment.

FIG. 2A illustrates an example of the hardware configuration of an information processing server, and FIG. 2B illustrates an example of the hardware configuration of a terminal apparatus according to one embodiment.

FIG. 3 illustrates an example of the functional configuration of the information processing server according to one embodiment.

FIG. 4 illustrates an example of a setting screen according to one embodiment.

FIG. 5 is a flowchart illustrating an example of a process which is performed by the information processing server according to one embodiment.

FIG. 6 illustrates an example of a pop-up screen according to one embodiment.

FIG. 7 illustrates an example of a setting screen according to one embodiment.

FIG. 8 is a flowchart illustrating an example of a process which is performed by the information processing server according to one embodiment.

FIG. 9 illustrates an example of the functional configuration of the information processing server according to one embodiment.

FIG. 10 illustrates an example of a setting screen according to one embodiment.

FIG. 11 is a flowchart illustrating an example of a process which is performed by the information processing server according to one embodiment.

### DESCRIPTION OF THE EMBODIMENTS

Various exemplary embodiments will be described in detail below with reference to the drawings.

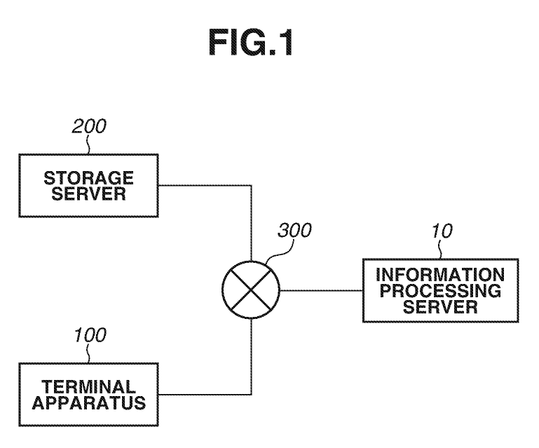

FIG. 1 illustrates an example of the configuration of an information processing system according to a first exemplary embodiment. The information processing system includes an information processing server 10, a terminal apparatus 100, and a storage server 200. The information processing server 10, the terminal apparatus 100, and the storage server 200 are communicably connected with one another via a network 300 such as a fixed telephone line network, a mobile telephone line network, the Internet, or a local area network (LAN).

The information processing server 10 is an apparatus which sets to data acquired from the storage server 200 label data indicating a category to which the acquired data belongs, among the categories such as “normal” and “noise” and assists generation of supervisory data. The label data is information which indicates a category to which the corresponding data belongs. The information processing system may include no storage server 200. In this case, the information processing server 10 stores information which is stored on the storage server 200.

The terminal apparatus 100 is an information processing apparatus which is used by an operator who performs data classification operation. The terminal apparatus 100 is, for example, a personal computer (PC), tablet PC, smartphone, or feature phone.

The storage server 200 is an information processing apparatus which stores data (hereinafter, “basic data”) based on which supervisory data is generated. The storage server 200 is a PC, smartphone, camera device, storage device, or the like. The storage server 200 transmits the stored data to the information processing server 10.

In the present exemplary embodiment, the information processing system generates supervisory data based on the normality of an action of a person using as basic data moving image data representing the action of the person.

The information processing system in the present exemplary embodiment presents to the operator a candidate for the data belonging to the “noise” category from the basic data. The operator performs an operation of setting label data to the presented data. Then, when there is no more data suspected of belonging to the “noise” category, the information processing system sets to the remaining data label data indicating that the data belongs to the “normal” category. In this way, the information processing system can increase the efficiency of the operation of generating supervisory data in the case where the data of the “noise” category is less than the data of the “normal” category.

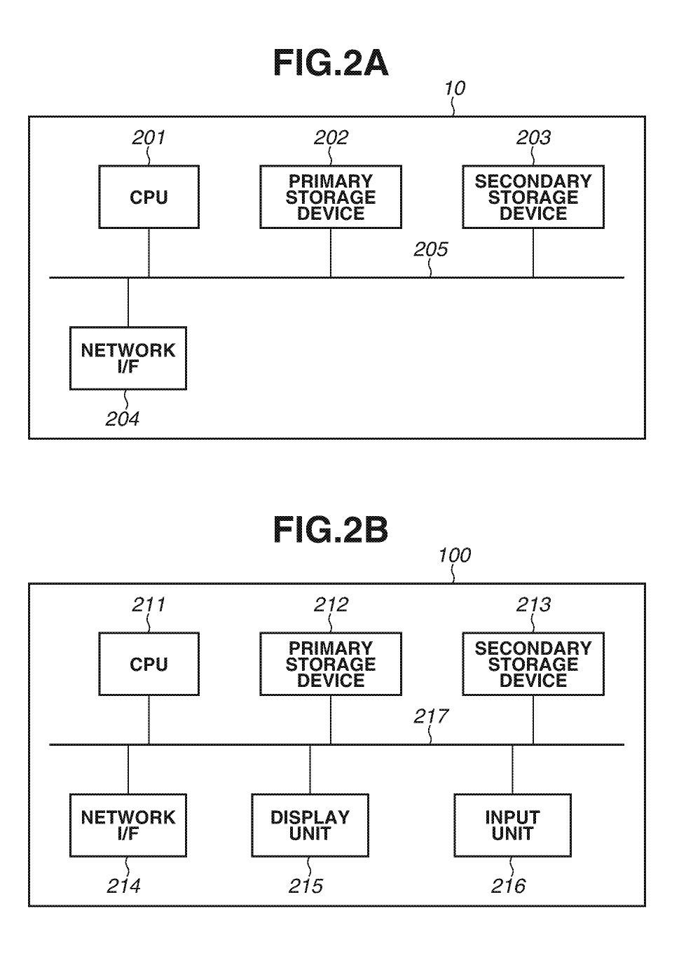

FIG. 2A illustrates an example of the hardware configuration of the information processing server 10. The information processing server 10 includes a central processing unit (CPU) 201, a primary storage device 202, a secondary storage device 203, and a network interface (I/F) 204, all of which are communicably connected with one another via a system bus 205.

The CPU 201 controls the processing of the information processing server 10. The primary storage device 202 is a storage device such as a random-access memory (RAM) which functions as a work area of the CPU 201, temporary storage location of information, etc. The secondary storage device 203 stores various programs, various types of setting information, supervisory data, candidate data for supervisory data, label information indicating a category of data, etc. The secondary storage device 203 includes a storage medium such as a read-only memory (ROM), hard disk drive (HDD), or solid-state drive (SSD). The network I/F 204 is used in communication with external devices such as the terminal apparatus 100 and the storage server 200 via the network 300.

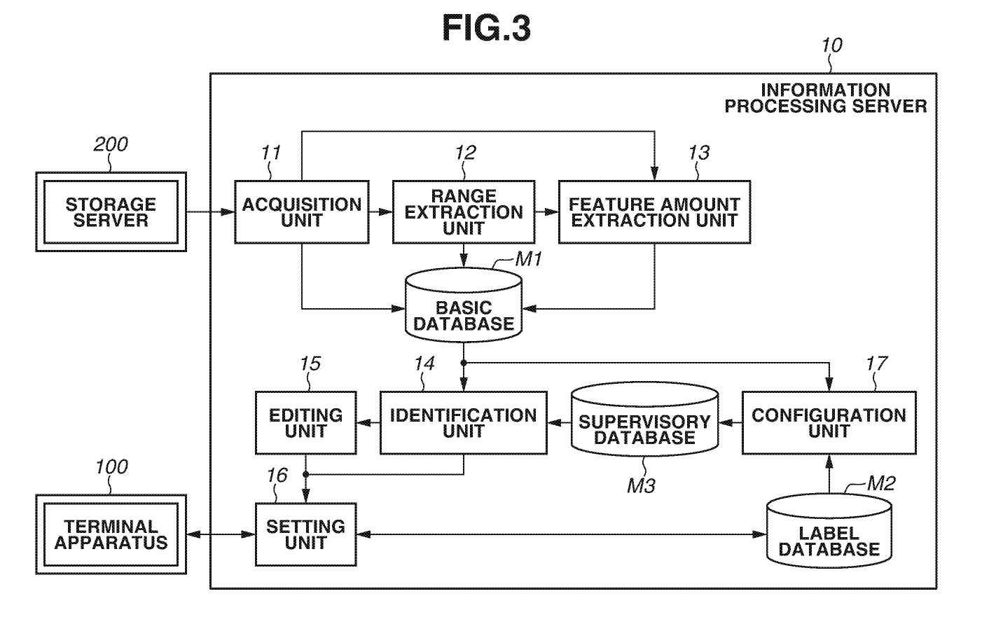

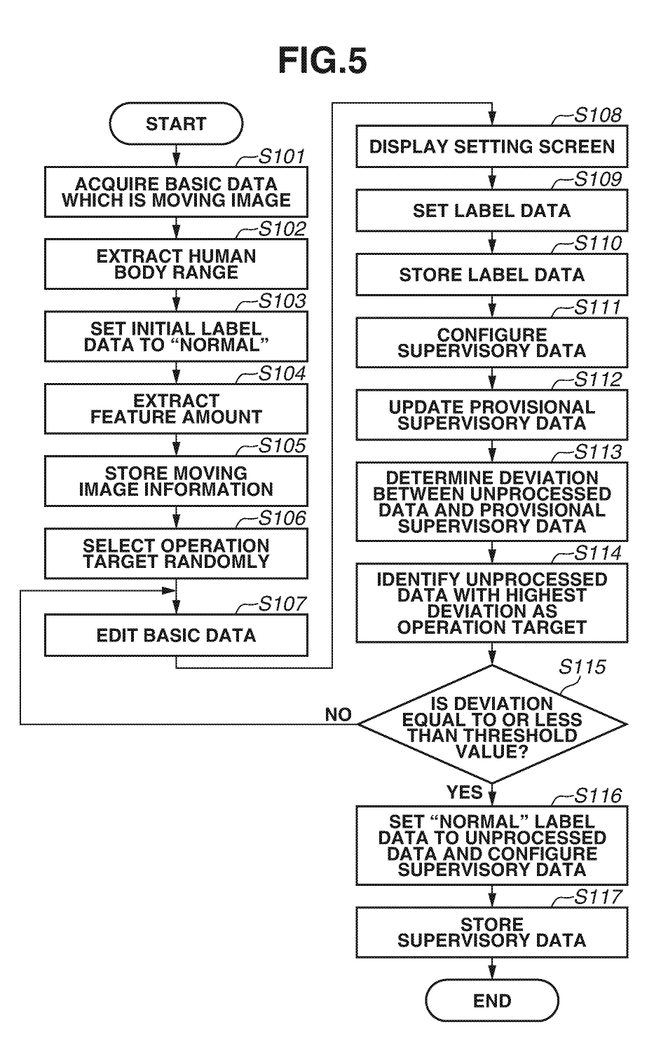

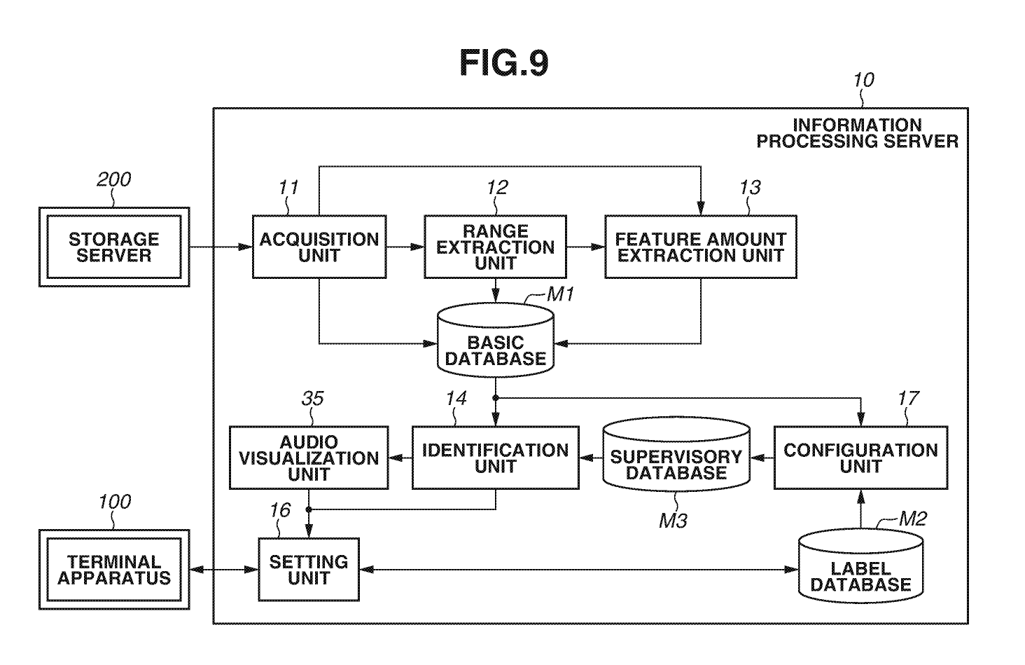

The CPU 201 executes processing based on a program stored in the secondary storage device 203 to realize the functions of the information processing server 10, which will be described below with reference to FIGS. 3 and 9, and processes illustrated in flowcharts, which will be described below with reference to FIGS. 5, 8, and 11.

In the present exemplary embodiment, the hardware configuration of the storage server 200 is similar to the hardware configuration of the information processing server 10 in FIG. 2A. A secondary storage device of the storage server 200 stores candidate data which is a candidate for supervisory data. A CPU of the storage server 200 executes processing based on a program stored in the secondary storage device of the storage server 200 to realize the functions of the storage server 200, processes of the storage server 200, etc.

FIG. 2B illustrates an example of the hardware configuration of the terminal apparatus 100. The terminal apparatus 100 includes a CPU 211, a primary storage device 212, a secondary storage device 213, a network I/F 214, a display unit 215, and an input unit 216, all of which are communicably connected with one another via a system bus 217.

The CPU 211 controls the processing of the terminal apparatus 100. The primary storage device 212 is a storage device such as a RAM which functions as a work area of the CPU 211, temporary storage location of information, etc. The secondary storage device 213 includes a storage medium such as a ROM, HDD, or SSD and stores various programs, various types of setting information, supervisory data, basic data, label data, etc. The network I/F 214 is used in communication with external devices such as the information processing server 10 and the storage server 200 via the network 300.

The display unit 215 displays information transmitted from the information processing server 10, etc. and includes a display device such as a liquid crystal panel or an organic electroluminescence (EL) panel. The display unit 215 displays moving image data, image data, and label data stored in the information processing server 10, buttons for use in setting label data, progress of candidate data classification operation, etc.

The input unit 216 includes input devices such as a touch sensor superimposed on the display unit 215 and hardware buttons. In the present exemplary embodiment, the input unit 216 includes the touch sensor superimposed on the display unit 215. The CPU 211 detects an operation performed with the finger of the operator or a touch pen via the input unit 216 and transmits, to the information processing server 10, information indicating the detected operation. The input unit 216 may include an input device such as a controller, keyboard, or mouse. In this case, the CPU 211 can acquire via the input unit 216 information indicating an operation performed by an operator on an image displayed on an image display panel. Examples of the operation information include information about an operation to provide an instruction to reproduce moving image data and an operation to select label data such as “normal” or “noise”.

The CPU 211 executes processing based on a program stored in the secondary storage device 213 to realize the functions of the terminal apparatus 100, processes of the terminal apparatus 100, etc.

FIG. 3 illustrates an example of the functional configuration of the information processing server 10, etc. The information processing server 10 includes an acquisition unit 11, a range extraction unit 12, a feature amount extraction unit 13, an identification unit 14, an editing unit 15, a setting unit 16, and a configuration unit 17. Further, a basic database M1, a label database M2, and a supervisory database M3 are implemented on the secondary storage device 203 of the information processing server 10.

The basic database M1 stores basic data acquired by the acquisition unit 11, information indicating a range extracted by the range extraction unit 12, information about a feature amount extracted by the feature amount extraction unit 13, and the like.

The label database M2 stores label data. The label data is data which indicates a category to which the corresponding data belongs. The label data is, for example, information which indicates one of the “normal” and “noise” categories. Alternatively, the label data may be information which indicates a category classified in more detail. For example, the label data may be information which indicates one of the categories “walk”, “upright”, “abnormal action”, “human body”, “non-human body”, etc. the corresponding data belongs. The label data may be, for example, information which indicates one category to which the corresponding data belongs, e.g., information which indicates that the corresponding data belongs to the “normal” category. Further, the label data may be, for example, information which indicates a plurality of categories to which the corresponding data belongs, e.g., information which indicates that the corresponding data belongs to the “human body” and “walk” categories.

The supervisory database M3 stores supervisory data. The supervisory data is used in machine learning and contains data extracted from the basic data (e.g., data which is a part of the basic data and extracted from the basic data, feature amount data extracted from the basic data, and basic data itself) and the label data. The supervisory data can be in the configuration corresponding to the required supervisory data format. The data extracted from the basic data contained in the supervisory data can be, for example, data which is a part of the basic data and extracted from the basic data (e.g., an image which is a part of an image and extracted from the image), the basic data, or a feature amount extracted from a part of the basic data.

The acquisition unit 11 acquires the basic data (in the present exemplary embodiment, moving image data) from the storage server 200 and stores the acquired basic data in the basic database M1. Further, the acquisition unit 11 transmits the acquired basic data to the range extraction unit 12 and the feature amount extraction unit 13. The acquisition unit 11 can acquire the basic data one by one sequentially, store the basic data one by one sequentially in the basic database M1, and transmit the basic data to the range extraction unit 12 and the feature amount extraction unit 13. Alternatively, the acquisition unit 11 can acquire all the basic data, store all the basic data in the basic database M1, and transmit the basic data to the range extraction unit 12 and the feature amount extraction unit 13. Furthermore, the acquisition unit 11 may acquire the basic data from the storage server 200 via the terminal apparatus 100 instead of acquiring the basic data directly from the storage server 200.

The range extraction unit 12 extracts a human body range from the basic data acquired by the acquisition unit 11. The range extracted as a range containing a human body will be referred to as “human body range”. The human body range is represented as, for example, information about a spatial/temporal range in which a person exists in a moving image. Specifically, a human body range extracted from a moving image is to be information which indicates at what time and at which coordinates in the moving image a person exits. A human body range extracted from a still image is to be information which indicates at which coordinates in the still image a person exists. Each area specified by a human body range in a moving image which is basic data is a human body range area. In the present exemplary embodiment, the human body range area is to be a label data setting target. Specifically, the supervisory data is to contain the information about the human body range area and the corresponding label data.

The range extraction unit 12 extracts a human body range for each person and sets, for each image in which a human body exits, information such as coordinates, a size on the image, time at which the human body appears/disappears on the moving image data, and a frame number. For example, in a case where two persons appear in a moving image, the range extraction unit 12 extracts two human body ranges and sets, as information about the human body ranges, information about the period and coordinates between appearance and disappearance of each person in the moving image.

Alternatively, for example, the range extraction unit 12 may detect a human body from basic data which is a moving image with respect to every frame of a moving image or may extract a human body with respect to every several frames and perform temporal interpolation. Further, the range extraction unit 12 may extract a plurality of human bodies which is temporally divided from a plurality of continuous frames with respect to the same person appearing continuously in a moving image. For example, in a case of changing action in which a person “walks” and “falls down” and then “walks” again, the range extraction unit 12 may extract human body ranges independently of each other in each time range in which an action occurs, using a method such as video segmentation or action recognition. Furthermore, the range extraction unit 12 may divide human body ranges at predetermined frame intervals. The range extraction unit 12 can extract human body ranges such that the human body ranges overlap spatially/temporally.

The range extraction unit 12 can extract human body ranges using, for example, a human body detection method based on human body shapes or a moving object detection method based on background differences. Further, the range extraction unit 12 may extract human body ranges using convolutional neural networks (CNN) for extracting pre-learned human body ranges. Furthermore, the range extraction unit 12 may extract the entire image as a human body range. The range extraction unit 12 stores extracted human body ranges in the basic database M1 in association with the basic data acquired by the acquisition unit 11. In addition, the range extraction unit 12 transmits the extracted human body ranges to the feature amount extraction unit 13.

The feature amount extraction unit 13 extracts respective feature amounts which correspond to the human body range areas in the moving image which is the basic data based on the basic data received from the acquisition unit 11 and the human body ranges extracted from the basic data received from the range extraction unit 12. The feature amount extraction unit 13 can extract a single type of feature amounts, a plurality of types of feature amounts, or a combination of a plurality of types of feature amounts as a single feature amount. The feature amount extraction unit 13 extracts, for example, feature amounts such as histograms of oriented gradients (HOG) feature amounts, scale-invariant feature transform (SIFT) feature amounts, face orientation, and moving speed. Further, the feature amount extraction unit 13 may extract an intermediate or last layer of CNN as a feature amount. Furthermore, the feature amount extraction unit 13 may extract, as a feature amount, wider information than a human body range such as information about the brightness of the entire image and weather information or meta-information outside the moving image data. Furthermore, the feature amount extraction unit 13 can extract feature amounts independently of each other with respect to a plurality of spatial/temporal portions of a human body range.

The feature amount extraction unit 13 stores the extracted feature amounts in the basic database M1 in association with the basic data acquired from the acquisition unit 11. The feature amounts stored in the basic database M1 are used for a comparison of images, as a part of supervisory data, or the like.

The identification unit 14 acquires the basic data, human body ranges, and feature amounts from the basic database M1. Further, the identification unit 14 acquires provisional supervisory data stored in the supervisory database M3. The provisional supervisory data is not final supervisory data but data provisionally determined as supervisory data. The provisional supervisory data is generated during a process of generating supervisory data and stored in the supervisory database M3. The provisional supervisory data contains data extracted from the basic data (in the present exemplary embodiment, an area in moving image which is the basic data) and the corresponding label data, as in the supervisory data. The area in the moving image which is the basic data contained in the provisional supervisory data will be referred to as “provisional supervisory area”. Then, the identification unit 14 identifies, based on the acquired basic data, human body range, feature amount, and provisional supervisory data, a human body range indicating an area to be a candidate for an area belonging to a category, e.g., “noise” category, different from the “normal” category. Then, the identification unit 14 sets the area specified by the identified human body range as a target of the next label data setting operation by the operator. The label data setting operation is performed by the operator to set label data via the input unit 216 of the terminal apparatus 100. The label data setting operation is an example of an operation for classifying a plurality of pieces of data. Further, the process of setting label data to a human body range area is an example of processing which classifies a human body range area. In the present exemplary embodiment, the human body range area specified by the human body range extracted by the range extraction unit 12 is to be a plurality of pieces of data of a classification target.

The identification unit 14 transmits the identified human body range to the editing unit 15. The human body range extracted by the range extraction unit 12 can be extracted as a range indicating the entire image or as a part of the image. The human body range can be a moving image temporally divided at predetermined time intervals or based on whether there is a change in the moving image.

The identification unit 14 behaves differently depending on whether supervisory data exists or does not exist in the supervisory database M3. In the present exemplary embodiment, the setting unit 16 sets for each human body range extracted by the range extraction unit 12 label data with respect to an area of a person in basic data corresponding to the human body range. Specifically, the supervisory data contains information about the area specified by the human body range and the corresponding label data. Further, each human body range area which is indicated by a human body range stored in the basic database M1 and to which no label data is set by the operator via the terminal apparatus 100 will be referred to as “unprocessed data”.

If no provisional supervisory data exists, the identification unit 14 randomly identifies from the unprocessed data a target of the next setting operation by the user. On the other hand, if provisional supervisory data exits, the identification unit 14 determines a deviation which indicates how much the unprocessed data deviates from the “normal” category, and identifies a human body range indicating an area to be a target of the next setting operation by the user based on the determined deviation. In the present exemplary embodiment, the identification unit 14 determines a deviation which indicates how much the unprocessed data deviates from the “normal” category based on the degree of deviation between the unprocessed data and the provisional supervisory data area. While the deviation is an index which indicates how much the unprocessed data deviates from the “normal” category, the deviation can also be considered as an index which indicates how much the unprocessed data is similar to the “normal” category if seen from an opposite viewpoint. For example, there can be a case in which the identification unit 14 determines as the deviation an index that a higher value of the index indicates a higher deviation. In this case, the deviation is an index that a higher value of the index indicates that the unprocessed data deviates from the “normal” category whereas a lower value of the index indicates that the unprocessed data is similar to the “normal” category. There can be an opposite case where, for example, the identification unit 14 determines as the deviation an index that a lower value of the index indicates a higher deviation. In this case, the deviation is an index that a higher value of the index indicates that the unprocessed data is similar to the “normal” category whereas a lower value of the index indicates that the unprocessed data deviates from the “normal” category.

The identification unit 14 determines a deviation with respect to each human body range if a moving image which is basic data contains a plurality of human body ranges. Further, the identification unit 14 can generate the deviation of the entire frame with respect to each frame in the moving image based on the deviations of the respective human body ranges. For example, the identification unit 14 can determine as the deviation of the entire frame the mean value or maximum value of deviations generated from human body ranges in the same frame, the number of human body ranges with a deviation which is not less than a threshold value, or the like. The identification unit 14 transmits the determined deviation to the setting unit 16.

The following describes a method of determining a deviation which indicates the degree of deviation between a provisional supervisory data area and unprocessed data, by the identification unit 14. The identification unit 14 calculates a deviation for each human body range corresponding to the unprocessed data.

One method for determining a deviation is a method in which the feature amount of a provisional supervisory data area is compared with the feature amount of unprocessed data which is a target for which a deviation is to be generated and the maximum value of the distance between the feature amounts is determined as a deviation. The identification unit 14 uses, for example, formula (1) below to determine as a deviation the degree of deviation between the provisional supervisory data area and the unprocessed data. Further, examples of a distance acquisition method include methods using the Euclidean distance, Hamming distance, Mahalanobis distance, etc.

$$d ( {x}_{i} \vert {y}_{1} , … , {y}_{N} ) = {min}_{j} {f}_{distance} ( {x}_{i} , {y}_{i} ) \qquad ( 1 )$$

In formula (1), d(x_i|y_l, . . . , y_N) denotes the degree of deviation between unprocessed data i and a provisional supervisory data area. In the present exemplary embodiment, the identification unit 14 determines the degree of deviation as a deviation. Further, x_i denotes the feature amount of the unprocessed data i. Further, y_j denotes the feature amount of data (in the present exemplary embodiment, an area) j extracted from the basic data contained in the provisional supervisory data. N denotes the number of pieces of data extracted from the basic data contained in the provisional supervisory data. Further, f_distance (x_i, y_j) denotes the distance between the feature amounts x_i and y_j. In the case where a plurality of feature amounts is extracted from the human body range area, the identification unit 14 can select a specific feature amount or can determine a deviation using all the feature amounts.

Another method for determining a deviation is a method using a classifier learned from the provisional supervisory data. In this method, the classifier is applied to unprocessed data to determine a deviation based on classification scores for “normal” and “noise”. The identification unit 14 realizes the method using, for example, formula (2) below.

d(xᵢ|M)=αsₙₒᵢₛₑ(xᵢ|M)−βsₙₒᵣₘₐₗ(xᵢ|M) (2)

In formula (2), d(x_i|M) denotes the deviation between unprocessed data i and a provisional supervisory data area. Further, M denotes dictionary data which defines the classifier learned from the provisional supervisory data. Further, s noise (x_i|M) and s normal (x_i|M) respectively denote the classification scores for the noise and normal classes with the dictionary data M given. Further, α and R denote coefficients for weight adjustment, and α, βϵ(0, 1). By this method, the higher the probability that the unprocessed data is noise is or the lower the probability that the unprocessed data is normal is, the higher the deviation between the unprocessed data and the provisional supervisory data becomes. The classifier is, for example, a support vector machine (SVM) or CNN. In a case of performing classification into multi-classes instead of two-class classification into “normal” and “noise”, for example, the identification unit 14 can calculate a deviation also by averaging classification scores for respective classes corresponding to normal and noise or by extracting a representative value. In the case where the supervisory data is not to contain data of the “noise” category, a one-class classifier into the normal class can be used. In this case, any method such as one-class SVM or CNN can be used.

The identification unit 14 may generate a similarity between a human body range area which is not identified as a target of the next label data setting operation and the identified human body range area. A method for determining the similarity between the areas is not limited to a single method. For example, the identification unit 14 may calculate the deviation between the areas and then determine the reciprocal number of the deviation as a similarity. The identification unit 14 may transmit to the setting unit 16 the determined similarity between the human body range area which is not identified and the identified human body range area.

The editing unit 15 edits the basic data based on the human body range area identified by the identification unit 14 and the deviation determined by the identification unit 14 and outputs the edited basic data and the corresponding deviation to the setting unit 16. More specifically, the editing unit 15 edits the basic data to increase the visibility of the area which is the label data setting target.

The moving image to be displayed on the terminal apparatus 100 for the label data setting operation does not have to be the entire image. Since the label data is set to the human body range area, there are cases where images in which no human body range area exists, e.g., frames without a person in the moving image do not have to be displayed. The editing unit 15 extracts only images in which a human body range area appears, so as to reduce the burden of checking the images by the operator performing the label data setting operation. However, in a case where the editing of moving image data is not required or there is a reason for retaining moving images of portions in which no human body range area exists, the editing unit 15 does not have to perform the editing processing described above. Further, even in a case where a human body range area exists, if the deviation from the supervisory data is equal to or less than the threshold value, the editing unit 15 can exclude the corresponding portion containing the human body range area from the extraction target. The reason therefor is that the lower the corresponding deviation is, the lower the probability that the human body range is noise data is, so that the necessity of checking is lower than those of other human body range areas.

The setting unit 16 provides for the terminal apparatus 100 a setting screen for use in the label data setting operation based on the edited basic data input from the editing unit 15 and the deviations of the respective human body range areas. Further, the setting unit 16 can acquire from the identification unit 14 information about human body range areas similar to the label data setting operation target area. The setting unit 16 displays a graphical user interface (GUI) (setting screen) for the label data setting operation on the display unit 215 of the terminal apparatus 100 to provide the GUI for the operator. Then, the setting unit 16 recognizes an operation performed by the operator via the input unit 216 of the terminal apparatus 100. The setting unit 16 determines label data corresponding to a human body range area based on the operation performed by the operator via the input unit 216 and stores in the label database M2 the determined label data in association with the human body range area.

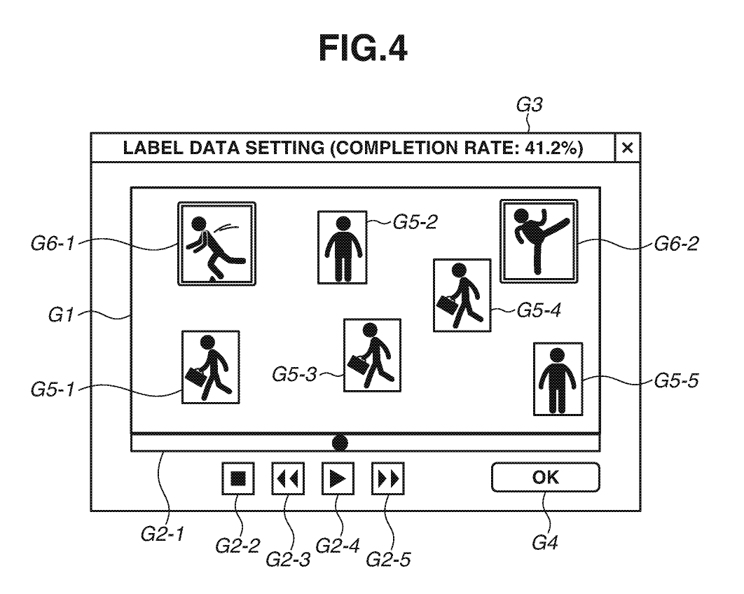

FIG. 4 illustrates an example of a label data setting screen in the present exemplary embodiment. In the example illustrated in FIG. 4, the setting screen includes an image display area G1, operation objects G2-1 to G2-5, a progress display area G3, an operation completion button G4, low deviation human body frames G5-1 to G5-5, and high deviation human body frames G6-1 and G6-2. The setting unit 16 detects via the CPU 211 an operation performed via the input unit 216 of the terminal apparatus 100 and controls the display of the above-described objects based on the detected operation. Further, the setting unit 16 may acquire from the terminal apparatus 100 information about an operation performed via the input unit 216 and detected by the CPU 211 and may control the display of the objects in the setting screen based on the acquired information. The process of the setting unit 16 is an example of a process of controlling displaying on the display unit 215. Hereinafter, a “tap” or “click” operation will be referred to simply as “click”.

The image display area G1 is an area where an image of the basic data edited by the editing unit 15 is displayed. If the resolution of the image is not the same as the size of the image display area G1, the setting unit 16 enlarges or reduces the image of the basic data to a preset size determined based on the ease of operation and displays the resulting image. The operation objects G2-1 to G2-5 include a seeking bar G2-1, a stop button G2-2, a rewind button G2-3, a reproduction button G2-4, and a fast-forward button G2-5. The operation objects G2-1 to G2-5 provide GUI components for performing various operations such as reproduction and a change in the reproduction position/speed for the image in the image display area G1.

The progress display area G3 displays progress information which indicates the progress of the label data setting operation. The progress information is expressed by, for example, the number of remaining data not having undergone the label data setting processing or the percentage of human body range areas with a deviation equal to or less than a set threshold value. The progress information displayed in the progress display area G3 enables the operator to check the progress of the operation in real time and roughly estimate the number of remaining steps of the operation.

The operation completion button G4 is clicked to complete the label data setting operation. The setting unit 16 detects the completion of the label data setting operation when detecting the selection of the operation completion button G4. Thereafter, the setting unit 16 stores in the label database M2 the label data set via the setting screen in association with the human body range.

The low deviation human body frames G5-1 to G5-5 and the high deviation human body frames G6-1 and G6-2 are frames specifying the human body range areas and are superimposed and displayed on the image of the basic data on the image display area G1. The setting unit 16 changes each human body frame in synchronization with the current frame of the basic data which is the moving image, and displays the changed human body frame in a position corresponding to a human body range extracted in the frame by the range extraction unit 12.

To emphasize that the possibility that a human body frame is noise data is higher than that of the other human body frames, the setting unit 16 can change the display form, e.g., color or shape, of the human body frame according to the deviation from the provisional supervisory data. For example, in the example illustrated in FIG. 4, the low deviation human body frames G5-1 to G5-5 specify human body ranges with a lower deviation than those specified by the high deviation human body frames G6-1 and G6-2, and the low deviation human body frames G5-1 to G5-5 are frames each displayed with a single real line. On the other hand, the high deviation human body frames G6-1 and G6-2 specify human body ranges with a higher deviation than those specified by the low deviation human body frames G5-1 to G5-5, and the high deviation human body frames G6-1 and G6-2 are frames each displayed with double lines. The setting unit 16 can change the display forms of the human body frames continuously according to the deviation. Further, the setting unit 16 can change the display forms of the human body frames according to the corresponding label data. For example, the setting unit 16 can display a human body frame in black if no label data is set or if the label data is an initial value, in blue if “normal” label data is set, or in red if “noise” label data is set.

If the operator clicks on a human body frame on the setting screen, the setting unit 16 detects the click. The setting unit 16 sets label data to the corresponding human body range area based on information about the detected click. For example, in the case where there are two types of label data which are the “normal” and “noise” categories, the setting unit 16 initializes all the human body ranges to have no label data. Then, if the setting unit 16 detects a click on a human body frame, the setting unit 16 sets label data indicating the “normal” category to the human body range area specified by the human body frame. Further, if the setting unit 16 detects a click on the human body frame corresponding to the human body range area to which the label data indicating the “normal” category is set, the setting unit 16 sets label data indicating the “noise” category to the human body range area specified by the human body frame. Further, if the setting unit 16 detects a click on the human body frame corresponding to the human body range area to which the label data indicating the “noise” category is set, the setting unit 16 sets label data indicating the “normal” category to the human body range area specified by the human body frame. In the present exemplary embodiment, the setting unit 16 collectively sets similar label data to all the human body range areas specified by the human body ranges corresponding to the human body range areas at the time of setting label data to the human body range areas. Furthermore, the setting unit 16 can initialize all the label data of the human body range areas with the label data indicating the “normal” category.

In this way, the human body range areas of noise data are visibly distinguishable from the normal human body range areas. As to an operation method for cases where there are more than two types of label data, there are a method in which label data is switched based on the number of clicks on a human body frame and a method in which a label data list pops up at the time of a click to select label data. Further, there is also a method in which label data is selected in advance and the selected label data is set at the time of a click.

The setting unit 16 detects a flick operation on a human body frame. Then, the setting unit 16 can perform label data setting on the human body frame based on the detected flick operation. For example, the setting unit 16 sets label data indicating the “normal” category if the setting unit 16 detects an upward flick on a human body frame, whereas the setting unit 16 sets label data indicating the “noise” category if the setting unit 16 detects a downward flick. As described above, the setting unit 16 may set label data based on the direction of a flick.

If the setting unit 16 detects a long tap on a human body frame or a long press of a mouse by the operator, the setting unit 16 can perform pop-up reproduction of an area similar to the corresponding human body range area. The setting unit 16 acquires from the identification unit 14 the similarity between the human body range areas not identified by the identification unit 14 and the human body range area identified by the identification unit 14. Then, if the setting unit 16 detects a long tap, or the like on the human body frame of the human body range area which is the operation target, the setting unit 16 performs the following process. Specifically, the setting unit 16 identifies based on the similarity acquired from the identification unit 14 a human body range area similar to the human body range area where the long tap, or the like has been detected, among the human body range areas not identified by the identification unit 14. For example, the setting unit 16 performs threshold value determination using a threshold value set to the acquired similarity to identify a human body range area similar to the human body range area where the long tap, or the like has been detected. Then, the setting unit 16 transmits to the terminal apparatus 100 a pop-up screen including the identified human body range area. The setting unit 16 displays the received pop-up screen on the display unit 215. The setting unit 16 enables the similar images to be checked to provide more information for making a decision to the operation when the operator dithers over which label data is to be set. Further, when setting label data, the setting unit 16 can collectively set common label data with respect to the similar human body range areas as needed.

The configuration unit 17 configures supervisory data based on the basic data and the human body ranges stored in the basic database M1 and the label data stored in the label database M2. For example, in a case where only the data of the “normal” category is needed, the configuration unit 17 configures supervisory data based on the data of the images of the human body range areas to which the “normal” label data is set.

Further, in a case where not image data but a feature amount is needed, the configuration unit 17 configures supervisory data containing the feature amount and the corresponding label data. In a case where an image and coordinates of a human body range are needed, the configuration unit 17 configures supervisory data containing the image indicated by the human body range extracted from the image indicated by the basic data, the coordinates of the human body range in the image indicated by the basic data, and the label data corresponding to the human body range. The configuration unit 17 stores the configured supervisory data in the supervisory database M3.

When the deviations of all the unprocessed data become equal to or less than the threshold value, it can be assumed that unprocessed data to which no label data is set belongs to the “normal” category. Thus, when the maximum value of the deviations becomes equal to or less than the threshold value, the setting unit 16 assumes that the label data setting operation is completed, and sets “normal” label data to all the unprocessed data. In the case where there is label data other than “normal” and “noise”, the setting unit 16 sets label data to maximize the classification score or to minimize the distance between the feature amounts by using the provisional supervisory data corresponding to the label data. Once there is no more unprocessed data, the information processing server 10 determines as final supervisory data the supervisory data stored in the supervisory database M3 and ends the operation of generating supervisory data.

FIG. 5 is a flowchart illustrating an example of the process to be performed by the information processing server 10 of the present exemplary embodiment. In step S101, the acquisition unit 11 acquires basic data which is a moving image from the storage server 200.

In step S102, the range extraction unit 12 extracts a human body range from each frame of the basic data acquired in step S101.

In step S103, the setting unit 16 sets label data indicating the “normal” category as an initial value of the label data to every human body range area specified by the human body ranges extracted in step S102. Then, the configuration unit 17 configures supervisory data containing the human body range areas specified by the human body ranges extracted in step S102 and the label data indicating the “normal” category as an initial value of provisional supervisory data and stores the configured supervisory data in the supervisory database M3. Since no label data is set by the operator to the respective provisional supervisory data areas in the initialized provisional supervisory data, all the data are unprocessed data at the point of step S103.

In step S104, the feature amount extraction unit 13 extracts a set feature amount from the respective human body range areas specified by the human body ranges extracted in step S102.

In step S105, the acquisition unit 11 stores in the basic database M1 the basic data acquired in step S101. The range extraction unit 12 stores in the basic database M1 the human body ranges extracted in step S102 in association with the basic data acquired in step S101. The feature amount extraction unit 13 stores in the basic database M1 the feature amounts extracted in step S104 in association with the basic data acquired in step S101 and the human body ranges extracted in step S102.

In step S106, the identification unit 14 randomly identifies a human body range area to be the first label data setting operation target. In the present exemplary embodiment, the identification unit 14 identifies a human body range and identifies every human body range area specified by the identified human body ranges as a label data setting operation target.

In step S107, the editing unit 15 edits the basic data acquired in step S101. A method for the editing is similar to the method described above with reference to FIG. 3.

In step S108, the setting unit 16 generates a setting screen for use in the label data setting operation based on the basic data edited in step S107 and provides the generated setting screen for the terminal apparatus 100. The setting screen in FIG. 4 is an example of the setting screen displayed in step S108. The setting unit 16 displays the provided setting screen on the display unit 215.

In step S109, the setting unit 16 receives designation of label data to the human body range areas based on an operation performed by the operator via the setting screen displayed in step S108. In the present exemplary embodiment, based on a click on a human body frame in the setting screen by the operator to designate the human body frame, the setting unit 16 sets label data indicating the “noise” category to the human body range area corresponding to the designated human body frame. If receiving the designation, the setting unit 16 sets the label data indicating the “noise” category to the human body range area corresponding to the human body frame on which the click is detected. In the present exemplary embodiment, the setting unit 16 collectively sets label data corresponding to the designation to each human body range area specified by the human body range corresponding to the human body range area on which the click is detected. If the setting unit 16 detects a click on the operation end button G4, the setting unit 16 ends the current label data setting operation.

In step S110, the setting unit 16 stores the label data set in step S109 in the label database M2 in association with the corresponding human body range area.

In step S111, the configuration unit 17 configures supervisory data based on the label data stored in association with the human body range area in step S110. In the present exemplary embodiment, the configuration unit 17 configures supervisory data containing the label data indicating the “noise” category and the human body range area.

In step S112, the configuration unit 17 updates the provisional supervisory data stored in the supervisory database M3 based on the supervisory data configured in step S111. In the present exemplary embodiment, the supervisory data configured by the information processing server 10 consists only of the data of the “normal” category. Thus, when step S112 is executed for the first time, the configuration unit 17 updates the provisional supervisory data by deleting the human body range area corresponding to the supervisory data configured in step S111 from the human body range areas contained in the provisional supervisory data initialized in step S103. In the second and subsequent execution of step S112, the configuration unit 17 updates the provisional supervisory data by deleting the human body range area corresponding to the supervisory data configured in previously-executed step S111 from the human body range areas contained in the provisional supervisory data stored in the supervisory database M3.

In step S113, the identification unit 14 determines the deviation between the provisional supervisory data area specified by the provisional supervisory data stored in the supervisory database M3 and the area specified by each piece of the unprocessed data.

In step S114, the identification unit 14 identifies the human body range area to be the next label data setting operation target based on the deviations determined in step S113.

The identification unit 14 can determine the deviation of each frame in the basic data acquired in step S101 which is the moving image, based on the deviations determined for the unprocessed data in step S113. Then, the identification unit 14 can identify a frame containing a human body range area to be a target of the next label data setting operation based on the deviations determined for the respective frames.

In step S115, the identification unit 14 determines whether the deviation corresponding to the unprocessed data (or frame, or the like) identified in step S114 is equal to or less than the preset threshold value. The deviation here is the index that a higher value of the index indicates a higher deviation. If the identification unit 14 determines that the deviation corresponding to the unprocessed data identified in step S114 is equal to or less than the preset threshold value (YES in step S115), the identification unit 14 determines that the label data setting operation is completed, and the processing proceeds to step S116. On the other hand, if the identification unit 14 determines that the deviation corresponding to the unprocessed data identified in step S114 is more than the preset threshold value (NO in step S115), the processing proceeds to step S107.

In step S116, the configuration unit 17 sets the label data indicating the “normal” category to every piece of unprocessed data. Then, the configuration unit 17 configures supervisory data with respect to the unprocessed data to which the label data indicating the “normal” category is set.

In step S117, the configuration unit 17 stores in the supervisory database M3 the supervisory data configured in step S116. The supervisory data stored in the supervisory database M3 at this point is determined as final supervisory data.

As described above, the information processing server 10 in the present exemplary embodiment determines the deviation which indicates the degree of deviation between each human body range area being a classification target and the provisional supervisory data area from which the human body range area confirmed as belonging to the “noise” category by the operator is deleted. Then, the information processing server 10 identifies as a target of the next label data setting operation a human body range area which is a candidate for the “noise” category, based on the determined deviations. In this way, the information processing server 10 determines, as the provisional supervisory data area, the human body range areas left by excluding the human body range areas to which the “noise” category is set by the user, from among the human body range areas being a classification target are deleted. Then, the information processing server 10 identifies a human body range area to be a candidate for the “noise” category based on the deviation between each human body range area being a classification target and the provisional supervisory data area. In this way, even when the initial value of the category of each piece of data contained in a plurality of pieces of data is undetermined, the information processing server 10 can identify data to be a candidate for data belonging to a category different from a set category from the plurality of pieces of data.

Further, the information processing server 10 sets the “normal” label data to all the data not having undergone the label data setting processing at the point at which there is no more data to be a candidate data of the “noise” category. In this way, the number of times of setting label data directly can be reduced to increase the efficiency of the label data setting operation of the information processing server 10.

Further, the information processing server 10 generates the level of progress of the label data setting operation with respect to the data to be a candidate data of the “noise” category and visualizes the level of progress on the GUI for label data setting. This enables the information processing server 10 to check the progress of the operation and estimate the amount of remaining operation so that the information processing server 10 can assist the operator in recognizing the status and increase the motivation of the operator.

Further, the information processing server 10 performs pop-up reproduction of an image similar to a human body range corresponding to a human body frame in response to a specific operation such as a long tap on the human body frame. This increases information for making a decision in the determination of label data of the human body frame so that the information processing server 10 can assist the operator in making a decision regarding the label data setting.

Furthermore, the information processing server 10 edits an image to be displayed through the editing unit 15 based on the presence/absence of a human body range and the deviations of the respective human body ranges. In this way, the operator does not have to check images in which no human body exists and images which do not have to be checked, so that the operator can efficiently check only necessary images.

Further, when identifying data to be a label data setting operation target through the identification unit 14, the information processing server 10 determines not the image but the human body range as the data. Then, the information processing server 10 adjusts the timing to update the provisional supervisory data. In this way, even in a case where basic data is a temporally-long moving image, the operator can efficiently delete data suspected of containing noise.

Furthermore, the information processing server 10 changes the display form of a human body frame indicating a human body range according to the deviation level. This enables the operator to recognize with ease which human body frame corresponds to a human body range with a high deviation, so that the operator can focus with ease on a person to be tracked.

Further, the information processing server 10 changes the display form of a human body frame indicating a human body range according to whether label data is set. This visualizes the label data setting state, so that the operator can intuitively recognize the label data setting state.

Furthermore, the information processing server 10 may perform the following processing.

The setting unit 16 can perform no initialization of the provisional supervisory data in step S103. Then, in step S109, the setting unit 16 receives designation of the label data indicating the “noise” category based on an operation performed by the operator via the setting screen displayed in step S108. Besides the foregoing, the setting unit 16 receives designation of the label data indicating the “normal” category based on an operation performed by the operator via the setting screen. In this case, if the setting unit 16 receives the designation, the setting unit 16 sets the label data indicating the “normal” category to the human body range area corresponding to the human body frame on which the click is detected. Then, in step S111, the configuration unit 17 configures supervisory data containing the label data indicating the “normal” category which is set in step S109 and the human body range area to which the label data indicating the “normal” category is set in step S109. Then, in step S112, the configuration unit 17 stores in the supervisory database M3 the supervisory data configured in step S111 as provisional supervisory data. In subsequent step S112, the configuration unit 17 updates the provisional supervisory data based on the supervisory data configured in previously-executed step S111. More specifically, the configuration unit 17 updates the provisional supervisory data by adding to the provisional supervisory data area the human body range area contained in the supervisory data configured in step S111.

Then, in step S113, the identification unit 14 determines the deviation between the unprocessed data and the provisional supervisory data area. In step S114, the identification unit 14 can determine a target of the next label data setting operation from the unprocessed data based on the deviations. The identification unit 14 determines the deviations using, for example, formula (1). In this case, the provisional supervisory data is data of the “normal” category. Thus, the determined deviations are indices that a higher value of the index indicates a higher deviation from the “normal” category. Then, the identification unit 14 determines as a target of the next label data setting operation, for example, the unprocessed data with a deviation higher than the set threshold value.

Further, the information processing server 10 may perform the following processing.

The setting unit 16 can perform no initialization of the provisional supervisory data in step S103. Then, in step S109, the setting unit 16 receives designation of the label data indicating the “noise” category based on an operation performed by the operator via the setting screen displayed in step S108. In this case, if the setting unit 16 receives the designation, the setting unit 16 sets the label data indicating the “noise” category to the human body range area corresponding to the human body frame on which the click is detected. Then, in step S111, the configuration unit 17 configures supervisory data containing the label data set in step S109 and the human body range area to which the label data is set in step S109. Then, in step S112, the configuration unit 17 can store in the supervisory database M3 the supervisory data configured in step S111 as provisional supervisory data. In subsequent step S112, the configuration unit 17 updates the provisional supervisory data based on the supervisory data configured in previously-executed step S111. More specifically, the configuration unit 17 updates the provisional supervisory data by adding to the provisional supervisory data area the human body range area contained in the supervisory data configured in step S111.

Then, in step S113, the identification unit 14 determines the deviation between the unprocessed data and the provisional supervisory data area. In step S114, the identification unit 14 can determine a target of the next label data setting operation from the unprocessed data based on the deviations. The identification unit 14 determines the deviations using, for example, formula (1). In this case, the provisional supervisory data is data of the “noise” category. Thus, the determined deviations are indices that a lower value of the index (a higher similarity to the provisional supervisory data) indicates a higher deviation from the “normal” category. Then, the identification unit 14 determines as a target of the next label data setting operation, for example, the unprocessed data with a deviation lower than the set threshold value.

There are cases where the same person in a moving image belongs to a category which changes with time. For example, in a case of a person who repeatedly moves and shoplifts, the person belongs to the “normal” category while moving, but the person belongs to the “noise” category while shoplifting.

In a second exemplary embodiment, a method will be described in which a human body range belonging to a changing category in a moving image is temporally divided and label data is efficiently set to the divided human body range. Hereinafter, each of the divided human body range will be referred to as a sub-human body range.

The configuration of the information processing system in the present exemplary embodiment is similar to that in the first exemplary embodiment. Further, the hardware and functional configurations of the components of the information processing system are similar to those in the first exemplary embodiment.

In the present exemplary embodiment, the data to be stored in the label database M2, the processing to be performed by the setting unit 16, and the processing to be performed by the configuration unit 17 are different from those in the first exemplary embodiment.

The label database M2 in the present exemplary embodiment stores for each sub-human body range the label data corresponding to the human body range area and input from the setting unit 16. The sub-human body range contains information about the coordinates of a human body in the image and start and end points specifying the temporal range.

The setting unit 16 generates a setting screen for use in the label data setting operation based on the basic data acquired from the editing unit 15 and the deviation, and provides the generated setting screen to the terminal apparatus 100, as in the first exemplary embodiment. The setting unit 16 collectively sets label data not for each human body range but for each sub-human body range with respect to the human body range area specified by the sub-human body range and stores the label data set for each sub-human body range in the label database M2, which is different from the first exemplary embodiment.

The following describes a method of setting label data to the sub-human body range by the setting unit 16. The setting unit 16 provides to the terminal apparatus 100 the setting screen as illustrated in FIG. 4. Further, the setting unit 16 provides to the terminal apparatus 100 a pop-up screen to be displayed in response to a click on a human body frame. The pop-up screen corresponding to the human body range will be referred to as “human body range pop-up screen”.

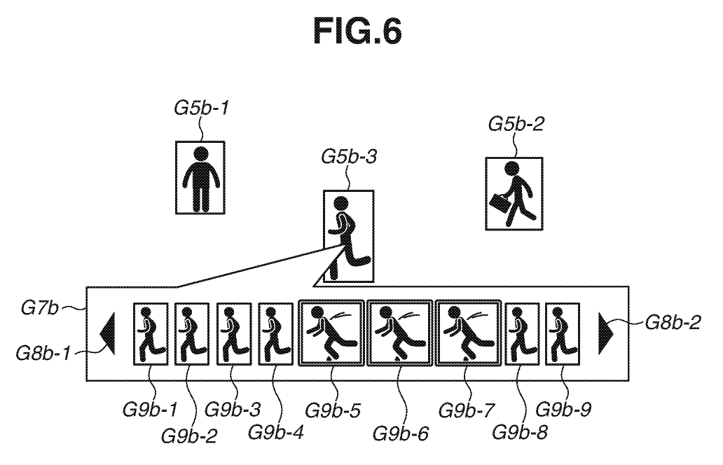

FIG. 6 illustrates an example of the human body range pop-up screen. In the example illustrated in FIG. 6, the setting screen includes human body frames G5b-1 to G5b-3, a human body range pop-up screen G7b, display range setting buttons G8b-1 and G8b-2, and human body range frame images G9b-1 to G9b-9.

The human body frames G5b-1 to G5b-3 indicate human body areas specified by human body ranges included in a frame in a moving image which is basic data, at a predetermined time. The setting unit 16 detects a click on the human body frame G5b-3 by the operator and displays the corresponding human body range pop-up screen G7b. The setting unit 16 can delete the human body range pop-up screen G7b when detecting a preset operation such as a click by the operator on a portion other than the human body range pop-up screen G7b.

The human body range pop-up screen G7b includes the human body range frame images G9b-1 to G9b-9. The human body range frame images G9b-1 to G9b-9 are images specifying human body range areas at the respective time points. The setting unit 16 tiles and displays the human body range frame images G9b-1 to G9b-9. Further, if the size of the human body range pop-up screen G7b is not large enough to display all human body range frame images, the setting unit 16 can display the human body range frame images that correspond to a temporally partial range. Furthermore, the setting unit 16 does not have to arrange and display the human body range frame images with respect to all the frames in the moving image and can display the human body range frame images according to the set number of frame intervals. Further, the setting unit 16 can display the human body range frame image that is representative and selected based on a specific criterion.

The display range setting buttons G8b-1 and G8b-2 are buttons included in the human body range pop-up screen G7b. The display range setting buttons G8b-1 and G8b-2 are buttons for designating a period containing a human body area to be displayed, among the human body areas corresponding to the human body ranges corresponding to the human body frame G5b-3. For example, if the setting unit 16 detects a click on the display range setting button G8b-1, the setting unit 16 displays the human body range areas of a more previous period. If the setting unit 16 detects a click on the display range setting button G8b-2, the setting unit 16 displays the human body range areas of a more subsequent period.

If the setting unit 16 detects a click on a human body range frame image, the setting unit 16 sets label data with respect to the human body range areas corresponding to the subsequent frames based on the frame corresponding to the human body range frame image on which the click is detected. If, for example, no label data is set, the setting unit 16 sets label data of the “normal” category. If, for example, label data of the “normal” category is set, the setting unit 16 sets label data of the “noise” category. If, for example, label data of the “noise” category is set, the setting unit 16 sets label data of the “normal” category. Further, the setting unit 16 determines as a single sub-human body range the human body areas of the same person which are temporally continuous and to which common label data is set.

The display form of the human body range frame images can be changed according to the corresponding label data or deviation. In the example illustrated in FIG. 6, the label data of the “noise” category is set to the human body range frame images G9b-5 to G9b-7. In this case, the setting unit 16 displays each of the human body range frame images G9b-5 to G9b-7 with a frame of double lines while displaying each of the other human body range frame images with a frame of a single line. The setting unit 16 may also change the color, the size, or the like besides the shape of the frame line.

The configuration unit 17 configures supervisory data based on the basic data stored in the basic database M1, the sub-human body range, and the label data stored in the label database M2. The configuration unit 17 uses the label data set for each sub-human body range instead of the label data set for each human body range, which is different from the first exemplary embodiment. The configuration unit 17 acquires for each sub-human body range a human body range area specified by the sub-human body range from the basic data and configures supervisory data containing the acquired human body range areas and the corresponding label data. Further, the configuration unit 17 can combine for each human body range the supervisory data configured for each sub-human body range. The configuration unit 17 stores the configured supervisory data in the supervisory database M3.

By the above-described processing according to the present exemplary embodiment, the information processing server 10 can suitably assist the user in performing the label data setting operation even in the case where the category to which the same person in the basic data which is a moving image belongs changes.

In a third exemplary embodiment, the processing to be performed by an information processing system in a case where not an image of a human body but an image of an article such as a sheet-metal is determined as basic data will be described below.

The configuration of the information processing system in the present exemplary embodiment is similar to that in the first exemplary embodiment. Further, the hardware and functional configurations of the components of the information processing system are similar to those in the first exemplary embodiment

In the present exemplary embodiment, the storage server 200 stores as basic data a still image of an article such as a sheet-metal.

The basic database M1 in the present exemplary embodiment stores in association with one another the basic data acquired by the acquisition unit 11, the setting range extracted by the range extraction unit 12, and the feature amount data extracted from each setting range of the image data by the feature amount extraction unit 13. In the present exemplary embodiment, the pieces of data stored in association with one another in the basic database M1 will collectively be referred to as “image information”.

The setting range is information which indicates the position of each area (e.g., patch) in the image in the image data which is to be a label data setting target. The setting range contains, for example, information about the coordinates of a label data setting target area in the image data. For example, in a case where image data of a component is divided into H (vertically)×W (horizontally) blocks to determine each block as a patch and label data is set to each patch, the setting range is, for example, the coordinates (i, j) indicating the position of the patch. As used herein, i and j are coordinate data which indicates the vertical and horizontal positions of the patch in the image data. Hereinafter, the area in the image which is specified by the setting range will be referred to as “setting range area”. In the present exemplary embodiment, each setting range area specified by the setting range extracted by the range extraction unit 12 is determined as classification target data.

Further, the setting range may be information which indicates the same coordinates in a plurality of pieces of image data. In this case, the setting range contains, for example, information for identifying image data. In a case where a part of the entire basic data which is a plurality of images is a label data setting target, the setting range contains, for example, a vector k which indicates an index of the image data being a label data setting target. Thus, the setting range is, for example, (i, j, k) indicating the coordinates of the patch in the image and the image index.

In the present exemplary embodiment, the feature amount extraction unit 13 extracts one set feature amount or a plurality of set feature amounts based on the setting range area.

In the present exemplary embodiment, the supervisory data contains the setting range area and the label data indicating the category to which the setting range area belongs. In the present exemplary embodiment, the label data is information indicating to which one of the “normal” category, which indicates that the article has no defect, and the “noise” category, which indicates that the article has a defect, the corresponding image data belongs.

The label database M2 in the present exemplary embodiment stores the label data set by the setting unit 16. The label data is set for each setting range. The label data indicates, for example, to which one of the “normal” category and the “noise” category the setting range area belongs. Alternatively, the label data may be information indicating to which one of the categories, which are more specific than the “normal” and “noise” categories, the setting range area belongs. The label data may be, for example, information indicating to which one of the categories indicating a normal surface, such as “flat surface” and “printed portion” categories, the setting range area belongs. Further, the label data may be information indicating to which one of the categories indicating a defect or noise, such as “scratch” and “recess” categories, the setting range area belongs.

The range extraction unit 12 in the present exemplary embodiment extracts a setting range from the image data acquired by the acquisition unit 11. The range extraction unit 12 can extract a patch to be a setting range using, for example, block division or a detector such as a corner or edge detector. The range extraction unit 12 can change the size of a pitch to be a setting range and the number of pieces of image data according to a problem. The range extraction unit 12 stores the extracted setting range in the basic database M1. Further, the range extraction unit 12 transmits the extracted setting range to the feature amount extraction unit 13.

The feature amount extraction unit 13 in the present exemplary embodiment extracts feature amount data corresponding to each setting range area based on the image data acquired from the acquisition unit 11 and the setting range acquired from the range extraction unit 12. The feature amount extraction unit 13 can extract a single feature amount or a combination of a plurality of feature amounts. The feature amount extraction unit 13 may extract a feature amount such as an average luminance, color histogram, or reproduction error by sparse coding or auto-encoder. In a case where the setting range indicates an area of the same coordinates in a plurality of images, the feature amount extraction unit 13 can extract, as a feature amount, difference information at the area between the image data.

Further, the feature amount extraction unit 13 can extract as a feature amount, as needed, wider information than the area indicated by the setting range such as the luminance of the entire image data or meta-information outside the image data. The feature amount extraction unit 13 stores the extracted feature amount in the basic database M1.

The identification unit 14 in the present exemplary embodiment identifies a setting range area to be the next label data setting operation target. The identification unit 14 transmits the identified setting range area to the editing unit 15. The identification unit 14 behaves differently depending on whether provisional supervisory data exists or does not exist in the supervisory database M3. Further, the setting range area to which no label data is set will be referred to as unprocessed data. In the case where provisional supervisory data does not exist, the identification unit 14 randomly identifies a setting target from the unprocessed data. In the case where provisional supervisory data exists, the identification unit 14 identifies a setting target based on the deviation between the provisional supervisory data area and the unprocessed data.

The identification unit 14 generates for each setting range the deviation from the provisional supervisory data. Further, in a case where there is a plurality of setting range areas corresponding to image data, the identification unit 14 can generate a deviation with respect to each setting range area and generate a deviation of the entire image data based on the deviations of the respective setting range areas. For example, the identification unit 14 can generate, as the deviation of the entire image data, the mean value or the maximum value of the deviations generated from the respective setting ranges or the number of setting ranges with a deviation which is not less than a threshold value.

The method of generating deviations by the identification unit 14 is similar to that in the first exemplary embodiment. The identification unit 14 can generate a similarity between the setting range area that is not identified and the identified setting range area, as in the first exemplary embodiment. The identification unit 14 transmits to the setting unit 16 the setting ranges that are not identified and the generated similarities.

The editing unit 15 acquires from the identification unit 14 the setting range area identified by the identification unit 14 and the deviation acquired by the identification unit 14. Then, the editing unit 15 edits the still image which is the basic data. The editing unit 15 transmits the edited image and the corresponding deviation to the setting unit 16. The editing unit 15 edits the image to increase the efficiency of the label data setting operation by the operator. Since the label data is set to the setting range area, editing the image to be displayed correspondingly to the setting range area is expected to increase the efficiency of operation by the operator. The editing unit 15 can perform editing to limit the image to be displayed on the display unit 215 to the setting range area. Further, the editing unit 15 can perform editing such that one setting range area or a plurality of setting range areas is superimposed and displayed on the entire image data as the image to be displayed on the display unit 215. In the case where there is a plurality of setting range areas, the editing unit 15 may perform editing to superimpose the setting range areas on the image.

However, the editing unit 15 does not have to perform editing if the editing of the image data is not required or if there is a reason for retaining the image of a portion other than the setting range area. Further, even in the case where a setting range exists in an image, if the deviation from the provisional supervisory data is equal to or less than the threshold value, the editing unit 15 can perform editing not to display the image containing the corresponding setting range area.

The setting unit 16 generates a setting screen for use in the label data setting based on the basic data edited by the editing unit 15, the setting ranges, and the corresponding deviations and provides the generated setting screen to the terminal apparatus 100. The setting unit 16 can acquire from the identification unit 14 the setting range areas that are not identified by the identification unit 14 and that are similar to the setting range area identified by the identification unit 14, and the corresponding similarities. The setting unit 16 stores the set label data in the label database M3 based on an operation performed via the setting screen by the operator.

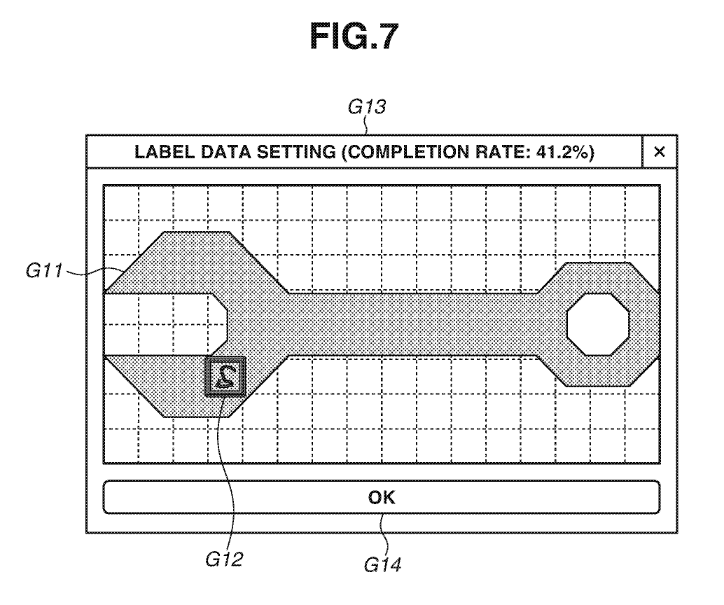

FIG. 7 illustrates an example of the setting screen for use in the label data setting in the present exemplary embodiment. In the example illustrated in FIG. 7, the setting screen includes an image display area G11, a high deviation patch G12, a progress display area G13, and an operation end button G14. The setting unit 16 detects an operation such as a click on the input unit 216 via the CPU 211 and controls the display of the objects according to the detected operation.

The image display area G11 contains an image edited and input by the editing unit 15. If the resolution of the image is not the same as the size of the image display area G11, the setting unit 16 enlarges or reduces the image display area G11 to a size determined based on the ease of operation. In a case where the display target is the entire image and the setting range area is a patch, the editing unit 15 edits the basic data such that the frame line indicating the boundary of the patch is superimposed and displayed on the image of the basic data. Further, in a case where the display target is the patch alone, the editing unit 15 can edit the basic data to display only the patch image. Further, in a case where the basic data is a plurality of images, the editing unit 15 can edit the basic data such that the images are arranged and displayed or the images are displayed and switched by an operation performed by the operator.

The high deviation patch G12 is a patch that corresponds to a setting range area with a higher deviation than that of a low deviation patch among the patches displayed in the image display area G11. Since a high deviation patch is likely the “noise” category, the display form such as the shape or color of the frame of the high deviation patch is changed to emphasize and display the high deviation patch. The display of the patch can be changed continuously according to the deviations. Further, the display of the patch can be changed correspondingly to the set label data regardless of the deviations. The progress display area G13 is an area where progress information about the label data setting operation is displayed. The progress information is expressed by, for example, the number of remaining unprocessed data or the percentage of image information with a deviation equal to or less than the threshold value. This enables the operator to check the progress of the operation in real time and roughly estimate the number of remaining steps of the operation. The operation end button G14 is a button which is clicked to end the label data setting operation. The label data set via the setting screen is stored in the label database M2.

If a click on the patch corresponding to the setting range area or on the entire image by the operator is detected, the setting unit 16 can set label data to the corresponding setting range area. For example, in the case where there is label data which indicates to which one of the two categories “normal” and “noise” the patch belongs, the setting unit 16 initializes the label data of all patches to indicate the “normal” category. Then, the setting unit 16 switches to indicate the “noise” category in response to a click on the patch. The setting unit 16 returns the label data to the “normal” category in response to a click performed again. In this way, a setting range area which is candidate noise data becomes distinguishable from the setting range area of the “normal” category. If the setting unit 16 is to collectively set label data to a plurality of patches, processing can be performed to switch the label data of patches near the clicked patch or switch the label data of patches over which the finger or cursor passes due to a drag over the image.

The setting unit 16 can set label data in response to a flick operation.

In response to a long tap on a setting range area or a long press on the mouse by the operator, an image similar to the setting range area on which the long tap, or the like is performed can be popped up and displayed. The similar image is generated based on the distance between the feature amounts of image information. By checking the similar image, the operator can refer to more information for making a decision when dithering over which label data is to be set. Further, the setting unit 16 can collectively set common label data to setting range areas similar to the setting range area which is clicked, or the like in the label data setting.

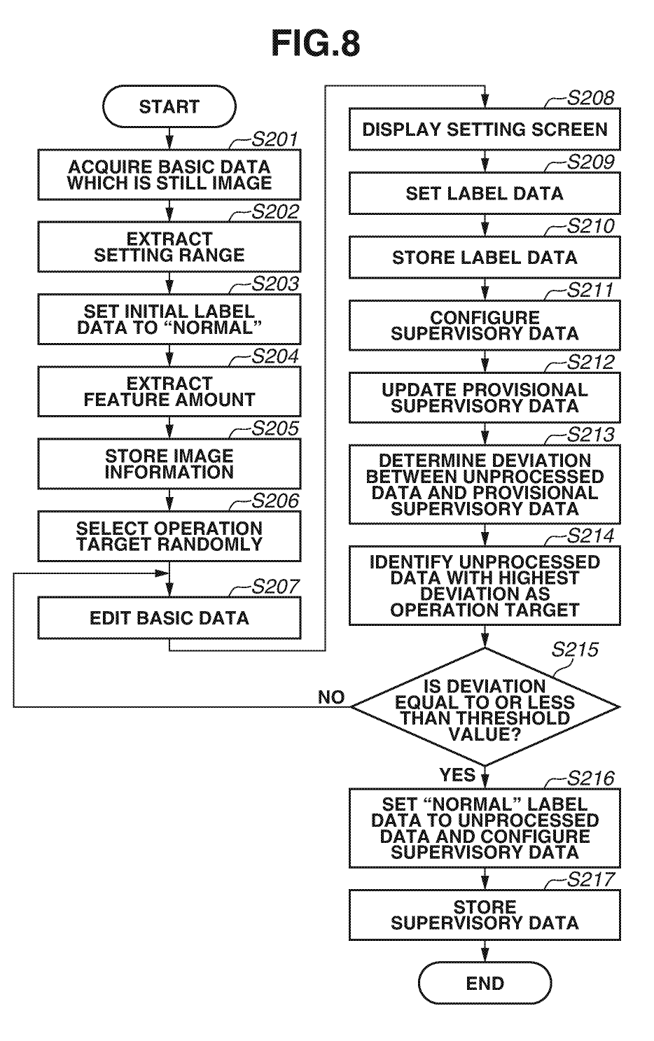

FIG. 8 is a flowchart illustrating an example of the process which is performed by the information processing server 10 in the present exemplary embodiment. The process of generating supervisory data in the present exemplary embodiment will be described below with reference to FIG. 8.

In step S201, the acquisition unit 11 acquires basic data which is a still image from the storage server 200.

In step S202, the range extraction unit 12 extracts a setting range from each still image which is the basic data acquired in step S201.

In step S203, the setting unit 16 sets label data indicating the “normal” category as an initial value of the label data to every setting range area specified by the setting ranges extracted in step S202. Then, the configuration unit 17 configures supervisory data containing the setting range areas specified by the setting ranges extracted in step S202 and the label data indicating the “normal” category, as an initial value of provisional supervisory data and stores the configured supervisory data in the supervisory database M3.

In step S204, the feature amount extraction unit 13 extracts a set feature amount from the images indicated by the setting range areas specified by the setting ranges extracted in step S202.

In step S205, the acquisition unit 11 stores in the basic database M1 the basic data acquired in step S201. The range extraction unit 12 stores in the basic database M1 the setting ranges extracted in step S202 in association with the basic data acquired in step S201. The feature amount extraction unit 13 stores in the basic database M1 the feature amounts extracted in step S204 in association with the basic data acquired in step S201 and the human body ranges extracted in step S202.

In step S206, the identification unit 14 randomly identifies the setting range area to be the first label data setting operation target.

In step S207, the editing unit 15 edits the basic data acquired in step S201.

In step S208, the setting unit 16 generates a setting screen for use in the label data setting operation based on the basic data edited in step S207 and provides the generated setting screen for the terminal apparatus 100. The setting screen in FIG. 7 is an example of the setting screen displayed in step S208. The setting unit 16 displays the provided setting screen on the display unit 215.

In step S209, the setting unit 16 receives designation of label data to the setting range areas based on an operation performed by the operator via the setting screen displayed in step S208. In the present exemplary embodiment, in response to a click on a patch in the setting screen by the operator, the setting unit 16 receives designation of the label data indicating the “noise” category with respect to the setting range area corresponding to the patch. If the setting unit 16 receives the designation, the setting unit 16 sets the label data indicating the “noise” category to the setting range area corresponding to the patch on which the click is detected. The setting unit 16 ends the current label data setting operation in response to a click on the operation end button G14.

In step S210, the setting unit 16 stores the label data set in step S209 in the label database M2 in association with the corresponding setting range area.

In step S211, the configuration unit 17 configures supervisory data based on the label data stored in association with the setting range area in step S210. In the present exemplary embodiment, the configuration unit 17 configures supervisory data containing the label data indicating the “noise” category and the setting range area.

In step S212, the configuration unit 17 updates the provisional supervisory data stored in the supervisory database M3 based on the supervisory data configured in step S211. In the present exemplary embodiment, the supervisory data configured by the information processing server 10 consists only of the data of the “normal” category. Thus, when step S212 is executed for the first time, the configuration unit 17 updates the provisional supervisory data by deleting the setting range area corresponding to the supervisory data configured in step S211 from the setting range areas contained in the provisional supervisory data initialized in step S203. In the second and subsequent execution of step S212, the configuration unit 17 updates the provisional supervisory data by deleting the setting range area corresponding to the supervisory data configured in previously-executed step S211 from the setting range areas contained in the provisional supervisory data stored in the supervisory database M3.

In step S213, the identification unit 14 determines the deviation between the provisional supervisory data area specified by the provisional supervisory data stored in the supervisory database M3 and the area specified by each piece of the unprocessed data.

In step S214, the identification unit 14 identifies a setting range area to be the next label data setting operation target based on the deviations determined in step S213.

In step S215, the identification unit 14 determines whether the deviation corresponding to the unprocessed data identified in step S214 is equal to or less than a preset threshold value. The deviation here is the index that a higher value of the index indicates a higher deviation. If the identification unit 14 determines that the deviation corresponding to the unprocessed data identified in step S214 is equal to or less than the preset threshold value (YES in step S215), the identification unit 14 determines that the label data setting operation is completed, and the processing proceeds to step S216. On the other hand, if the identification unit 14 determines that the deviation corresponding to the unprocessed data identified in step S214 is more than the preset threshold value (NO in step S215), the processing proceeds to step S207.

In step S216, the configuration unit 17 sets the label data indicating the “normal” category to every piece of unprocessed data. Then, the configuration unit 17 configures supervisory data with respect to the unprocessed data to which the label data indicating the “normal” category is set. In the present exemplary embodiment, since the initial value of the label data is set to every human body range area in step S203, the configuration unit 17 does not have to configure supervisory data again in step S216.

In step S217, the configuration unit 17 stores in the supervisory database M3 the supervisory data configured in step S216. The supervisory data stored in the supervisory database M3 at this point is determined as final supervisory data.

As described above, the information processing server 10 in the present exemplary embodiment determines as a provisional supervisory data area the classification target human body range area excluding the setting range area with respect to which the “noise” category is designated by the user. Then, the information processing server 10 identifies a setting range area to be a candidate for the “noise” category based on the deviations between the respective classification target setting range areas and the provisional supervisory data area. In this way, even when the initial value of the category of each piece of data contained in a plurality of pieces of data is undetermined, the information processing server 10 can identify data to be a candidate for data belonging to a category different from a set category from the plurality of pieces of data.

Further, the editing unit 15 edits an image to be displayed based on the presence/absence of a setting range area and the deviations of the respective setting ranges. In this way, the operator does not check images in which no setting range exists and images having a deviation which is so low that the necessity to check is low, so that the operator can efficiently check only necessary images.

Further, the patch of the setting range area with a high deviation is emphasized and displayed to make it easy to recognize which patch corresponds to the setting range with a high deviation, so that the operator can focus with ease on the patch to be tracked.

Further, the appearance of a patch such as the color and shape of the patch is changed according to the label data setting state to visualize the label data setting state so that the operator can intuitively recognize the label data setting state.

In a fourth exemplary embodiment, the processing to be performed by an information processing system in a case where the basic data is audio data will be described below.

The configuration of the information processing system in the present exemplary embodiment is similar to that in the first exemplary embodiment. Further, the hardware configurations of the information processing server 10 and the storage server 200 are similar to those in the first exemplary embodiment. The terminal apparatus 100 further includes an audio output unit including a speaker, earphones, or a headphone in addition to the hardware configuration illustrated in FIG. 2B. The setting unit 16 reproduces audio transmitted from the setting unit 16 with the audio output unit via the CPU 211. Further, the setting unit 16 can change the volume of the reproduction via the audio output unit according to an operation performed via the input unit 216. In the present exemplary embodiment, the supervisory data contains one piece of audio data or a plurality of pieces of audio data and label data indicating the category to which the audio data belongs.

Further, the category to which data of speech belongs is the “normal” category. Further, the category to which audio data not belonging to the “normal” category such as audio data of environmental sound or soundless audio data belongs is the “noise” category.

FIG. 9 illustrates an example of the functional configuration of the information processing server 10 in the present exemplary embodiment, etc. The functional configuration of the information processing server 10 in FIG. 9 is different from that in FIG. 3 in that an audio visualization unit 35 is included in place of the editing unit 15.

The basic database M1 stores in association with one another the basic data which is audio data acquired from the storage server 200 by the acquisition unit 11, the setting ranges extracted from the basic data by the range extraction unit 12, and the feature amount data extracted from each setting range by the feature amount extraction unit 13. The pieces of data stored in association with one another in the basic database M1 will collectively be referred to as “audio information”.

The setting range is information which indicates an entire part of the audio data which is the basic data or a continuous part in the audio data which is to be a label data setting target. The audio data of the portion in the basic data which is specified by the setting range is setting range data. In the present exemplary embodiment, the setting range data is classification target data. For example, the setting range is expressed by information about temporal start and end points in the audio data.

The feature amount data is extracted by the feature amount extraction unit 13 from the audio data specified by the setting range. The feature amount extraction unit 13 extracts feature amounts of a single set type or a plurality of set types.

In the present exemplary embodiment, the label data stored in the label database M2 is label data set for each setting range. The label data can be information indicating to which one of the “normal” and “noise” categories audio data belongs or information indicating to which one of a plurality of more specific categories audio data belongs. For example, the label data can be information indicating to which one of “male voice”, “female voice”, “noise sound”, and “soundless” categories audio data belongs.

The supervisory database M3 stores supervisory data configured by the configuration unit 17 and containing audio information and label data. The specific configuration of the supervisory data changes depending on the supervisory data format which is needed. The supervisory data stored in the supervisory database M3 is updated additionally as the operation of generating supervisory data progresses. The identification unit 14 acquires the supervisory data from the supervisory database M3 to use the supervisory data.

The acquisition unit 11 acquires from the storage server 200 the basic data which is audio data and outputs the basic data to the basic database M1, the range extraction unit 12, and the feature amount extraction unit 13. The acquisition unit 11 can sequentially acquire and output audio data or acquire all audio data and then collectively output the acquired audio data. The acquisition unit 11 can acquire the audio data via the terminal apparatus 100 instead of acquiring the audio data directly from the storage server 200.

The range extraction unit 12 extracts a setting range to be a label data setting target from the audio data which is the basic data acquired by the acquisition unit 11. A method of extracting a setting range is not limited to a particular method. For example, the range extraction unit 12 can extract a setting range using a method of dividing at predetermined time intervals, a method of dividing at timings at which the volume decreases, or the like. Further, the range extraction unit 12 can extract as a setting range a range detected using a word detector, or the like. The range extraction unit 12 stores the extracted setting range in the basic database M1 and transmits the extracted setting range to the feature amount extraction unit 13.

The feature amount extraction unit 13 extracts feature amount data corresponding to a setting range based on the audio data acquired by the acquisition unit 11 and the setting range extracted by the range extraction unit 12. The feature amount extraction unit 13 extracts a single set feature amount or a plurality of set feature amounts. For example, the feature amount extraction unit 13 extracts a learning feature amount based on the mel-frequency cepstrum coefficients (MFCC) and deep learning. The feature amount extraction unit 13 can also extract as a feature amount, wider information than the setting range, such as the volume level of the entire audio data, or meta-information outside the audio data, as needed. The feature amount extraction unit 13 stores the extracted feature amount data in the basic database M1.

The identification unit 14 identifies setting range data to be the next label data setting operation target based on the audio information acquired from the basic database M1 and the provisional supervisory data acquired from the supervisory database M3. The identification unit 14 transmits the identified setting range data to the audio visualization unit 35.

The identification unit 14 behaves differently depending on whether provisional supervisory data exists or does not exist in the supervisory database M3. If provisional supervisory data does not exist, the identification unit 14 randomly identifies a next setting operation target from the unprocessed data. On the other hand, if provisional supervisory data exists, the identification unit 14 identifies a next setting operation target based on the deviation between the audio data indicated by the provisional supervisory data and the unprocessed data. Hereinafter, the audio data indicated by the provisional supervisory data is provisional supervisory audio data. In the present exemplary embodiment, the unprocessed data is setting range data with respect to which no label data is designated.

The identification unit 14 determines a deviation for each setting range. However, in a case where a plurality of pieces of setting range data exists in given audio data, the identification unit 14 can generate a deviation for each setting range data and determine a deviation of the entire audio data based on the deviations of the respective pieces of setting range data. For example, the identification unit 14 can determine the deviation of the entire audio data using the mean value and the maximum value of the deviations generated from the respective pieces of setting range data, the number of pieces of setting range data having a deviation that is not less than the threshold value, or the like.

The method of generating a deviation by the identification unit 14 is similar to that in the first exemplary embodiment. The identification unit 14 can generate a similarity with respect to audio information that is not identified as a setting operation target, as in the first exemplary embodiment.

The audio visualization unit 35 generates an image by visualizing the audio data which is the basic data. Further, the audio visualization unit 35 visualizes on the visualized audio data the area specified by the setting range data based on the setting range data identified by the identification unit 14 and the deviations determined by the identification unit 14. Hereinafter, the area specified by the setting range data on the visualized audio data image is a setting range area. The audio visualization unit 35 outputs the audio information, the deviation, and the visualized image to the setting unit 16. The audio information is visualized so that the operator can estimate the feature of audio before the reproduction of the audio, and this is expected to increase the operation efficiency compared to the case where the entire audio is reproduced. For example, in the case of visualizing the audio volume, the operator can assume that abnormal sound is produced in a portion in which the volume suddenly increases or that a portion in which the volume is extremely low is a soundless portion. The audio visualization unit 35 can visualize audio data by, for example, generating a line graph representing the volume. Further, the audio visualization unit 35 can visualize audio data by generating an image of a waveform based on the frequency specified by the audio data. Further, the audio visualization unit 35 can visualize audio data by changing the color according to the pitch of sound or by using a display of an icon indicating similar sound. Further, the audio visualization unit 35 can generate a plurality of types of images by visualizing audio data.

However, the audio visualization unit 35 is not to visualize the corresponding audio data if no setting range data is extracted or if the deviation from the provisional supervisory data is equal to or less than the threshold value, because the operator can efficiently check the label data setting target if only the label data setting target is visualized and a setting range with a low deviation is less likely noise data and the necessity to check such a setting range is low.

The setting unit 16 generates a setting screen for use in the label data setting operation based on the audio information, the deviation, and the visualized image input from the audio visualization unit 35 and provides the generated setting screen to the terminal apparatus 100. The setting unit 16 provides a unit for the operator to set label data using the audio information which is input from the identification unit 14 and is not selected and the corresponding similarity. The setting unit 16 displays the setting screen on the display unit 215 via the CPU 211 and recognizes operations performed by the operator on the input unit 216.

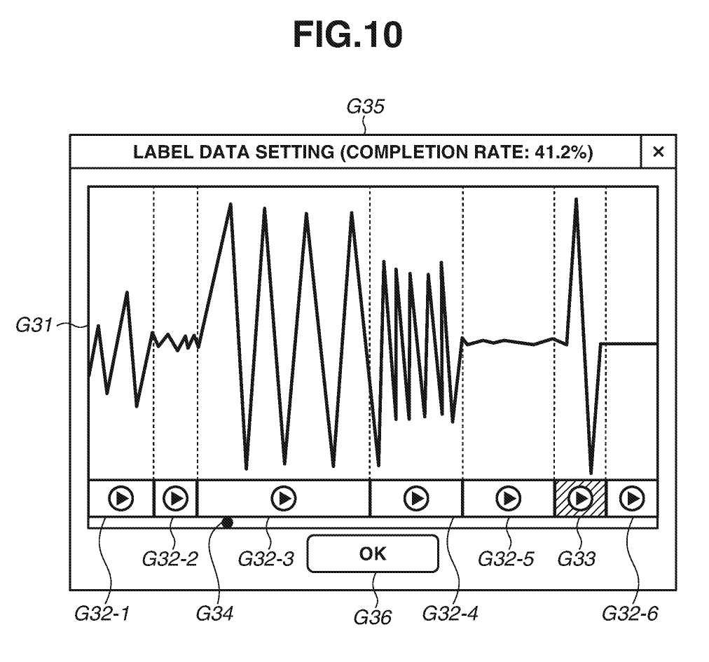

FIG. 10 illustrates an example of the setting screen for use in the label data setting operation in the present exemplary embodiment. In the example in FIG. 10, the setting screen includes an image display area G31, low deviation reproduction buttons G32-1 to G32-6, a high deviation reproduction button G33, a seeking bar G34, a progress display area G35, and an operation end button G36. The setting unit 16 detects information, or the like. such as a click on the input unit 216 or the cursor position and controls the display of the objects based on the detected operation, or the like.

The image display area G31 is an area where an image input from the audio visualization unit 35 is displayed. The setting unit 16 can increase or decrease the resolution of the image to be displayed in the image display area G31 based on the size of the image display area G31. Further, if the size of the image to be displayed in the image display area G31 is larger than the size of the image display area G31, the setting unit 16 displays a part of the image and allows the user to change the display position with a scroll bar. The setting unit 16 displays boundary lines with respect to the portions of the visualized image that correspond to the boundaries of the respective pieces of setting range data. The setting unit 16 can display each setting range area in the image in a display form corresponding to the deviation. For example, the setting unit 16 can make the background pale if the deviation is low, whereas the setting unit 16 can make the background dark if the deviation is high.

The low deviation reproduction buttons G32-1 to G32-6 are reproduction buttons corresponding to the setting ranges with a low deviation, and the high deviation reproduction button G33 is a reproduction button corresponding to the setting range with a high deviation. If the setting unit 16 detects a click on the reproduction buttons, audio data of the corresponding setting range area is output via the audio output unit. If the setting unit 16 can pause the reproduction if a click is detected on the reproduction buttons again during the audio reproduction. The setting unit 16 can resume the audio reproduction from the paused position if a click on the reproduction buttons is detected again. The setting unit 16 can change the display forms of the respective reproduction buttons according to the value of the deviation. For example, the setting unit 16 can display the buttons in color closer to black or emphasize and display the frame line at a higher deviation. In this way, the setting ranges with a high deviation become visually recognizable. Further, the setting unit 16 can change the display forms of the buttons according to the set label data.

The seeking bar G34 is a seeking bar which indicates the reproduction position of audio. The seeking bar can correspond to the entire audio data, or a separate seeking bar can be provided for each setting range.

The progress display area G35 is an area where the progress information about the label data setting operation is displayed. The progress information is expressed by, for example, the number of remaining unprocessed data or the percentage of the setting range data with a deviation equal to or less than the threshold value. This enables the operator to check the progress of the operation in real time and roughly estimate the number of remaining steps of the operation. If a click on the operation end button G36 is detected, the setting unit 16 ends the label data setting operation. The setting unit 16 outputs the label data set on the setting screen to the label database M2.

The operator performs an operation to set label data to a setting range by clicking an area on the image display area G31 which corresponds to the setting range. For example, if there is label data indicating to which one of the two categories “normal” and “noise” data belongs, the setting unit 16 performs initialization such that the label data of every setting range indicates the “normal” category. Then, the setting unit 16 switches to the label data indicating the “noise” category in response to a click on the setting range area. The setting unit 16 switches to the label data indicating the “normal” category in response to a click performed again on the setting range area. In this way, the setting ranges that are likely noise data become distinguishable from the normal setting ranges. As to an operation method for cases where there are more than two types of label data, there are a method in which label data is switched based on the number of clicks on a setting range and a method in which a label data list pops up at the time of a click to select label data. Further, there is also a method in which label data is selected in advance and the selected label data is set at the time of a click. To collectively set label data to a plurality of setting ranges, a method can be used in which the label data of the setting range over which the finger or cursor passes due to a drag on the image is switched.

The setting unit 16 can set label data according to a flick operation on the setting range area. For example, the setting unit 16 sets the label data indicating the “normal” category in response to an upward flick and sets the label data indicating the “noise” category in response to a downward flick.

If a long tap on the setting range area or a long press of the mouse by the operator is detected, the setting unit 16 can perform pop-up display of audio information similar to the corresponding setting range data. Allowing the operator to check the similar audio, the information processing server 10 provides more information for making a decision for the operator even when the operator dithers over which label data is to be set. Further, the setting unit 16 can collectively set common label data also to the similar setting range data at the time of setting label data to the setting range data.

The configuration unit 17 configures supervisory data containing the setting range data and the label data corresponding to the setting range data and stored in the label database M9. The configuration method corresponds to the supervisory data format which is needed. For example, in a case where only the normal audio data is needed, the configuration unit 17 configures supervisory data using the audio data to which the “normal” label data is set. Further, in a case where not the audio data but only the feature amounts are needed, the configuration unit 17 configures supervisory data using the feature amounts and the label data. The configuration unit 17 stores the configured supervisory data in the supervisory database M3.

When the deviations of all the unprocessed data become equal to or less than the threshold value, it can be assumed that all the remaining unprocessed data belong to the “normal” category. Thus, when the maximum value of the deviations becomes equal to or less than the threshold value, the configuration unit 17 assumes that the label data setting operation is completed, sets “normal” label data to all the unprocessed data, and configures supervisory data. In the case where there is label data other than “normal” and “noise”, the setting unit 16 sets label data to maximize the classification score or to minimize the distance between the feature amounts using the provisional supervisory data corresponding to the label data. The supervisory data stored in the supervisory database M3 at the time when there is no more unprocessed data is determined as final supervisory data.

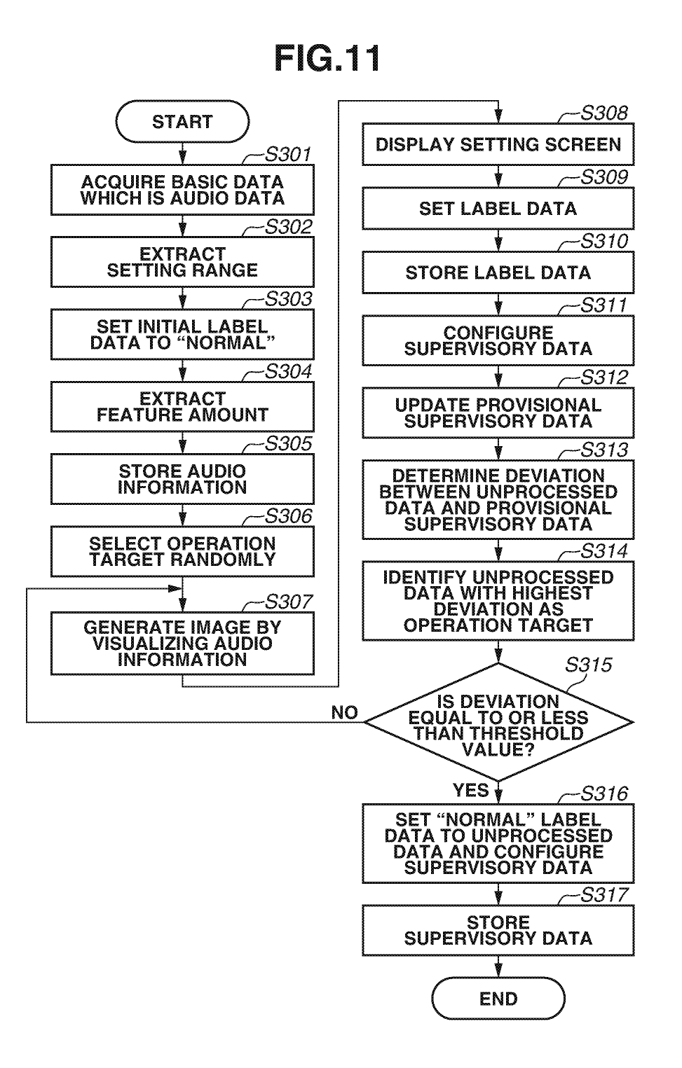

FIG. 11 is a flowchart illustrating an example of the process to be performed by the information processing server 10 of the present exemplary embodiment. The process of generating supervisory data in the present exemplary embodiment will be described below with reference to FIG. 11.

In step S301, the acquisition unit 11 acquires basic data which is audio data from the storage server 200.

In step S302, the range extraction unit 12 extracts a setting range from the audio data which is the basic data acquired in step S301.

In step S303, the setting unit 16 sets the label data indicating the “normal” category as the initial value of the label data with respect to all the setting range data indicated by the setting range extracted in step S302. Then, the configuration unit 17 configures supervisory data containing setting range data indicated by the setting range extracted in step S302 and the label data indicating the “normal” category, as the initial value of the provisional supervisory data, and stores the configured supervisory data in the supervisory database M3.

In step S304, the feature amount extraction unit 13 extracts a set feature amount from the audio data indicated by each piece of setting range data indicated by the setting range extracted in step S302.

In step S305, the acquisition unit 11 stores in the basic database M1 the basic data acquired in step S301. The range extraction unit 12 stores in the basic database M1 the setting range extracted in step S302 in association with the basic data acquired in step S301. The feature amount extraction unit 13 stores in the basic database M1 the feature amount extracted in step S304 in association with the basic data acquired in step S301 and the setting range extracted in step S302.

In step S306, the identification unit 14 randomly identifies setting range data to be a target of the first label data setting operation.

In step S307, the audio visualization unit 35 visualizes the audio data which is the basic data acquired in step S301. The visualization method is similar to that described above with reference to FIG. 9.

In step S308, the setting unit 16 generates a setting screen for use in the label data setting operation based on the basic data edited in step S307 and provides the generated setting screen for the terminal apparatus 100. The setting screen in FIG. 10 is an example of the setting screen displayed in step S308. The setting unit 16 instructs the CPU 211 to display the provided setting screen on the display unit 215 so that the setting screen is displayed on the display unit 215.

The operator checks the image displayed on the setting screen to check the presence/absence of noise data while reproducing audio as needed. If noise data is detected, the setting range area of the noise data is clicked.

In step S309, the setting unit 16 receives designation of label data with respect to the setting range data based on an operation performed by the operator via the setting screen displayed in step S308. In the present exemplary embodiment, in response to a click on the setting range area in the setting screen by the operator, the setting unit 16 receives designation of the label data indicating the “noise” category with respect to the setting range data corresponding to the patch. If the setting unit 16 receives the designation, the setting unit 16 sets the label data indicating the “noise” category to the setting range area corresponding to the patch on which the click is detected. The setting unit 16 ends the current label data setting operation in response to a click on the operation end button G14.

In step S310, the setting unit 16 stores the label data set in step S309 in the label database M2 in association with the corresponding setting range data.

In step S311, the configuration unit 17 configures supervisory data based on the label data stored in association with the setting range area in step S310. In the present exemplary embodiment, the configuration unit 17 configures supervisory data containing the label data indicating the “noise” category and the setting range area.

In step S312, the configuration unit 17 updates the provisional supervisory data stored in the supervisory database M3 based on the supervisory data configured in step S311. In the present exemplary embodiment, the supervisory data configured by the information processing server 10 consists only of the data of the “normal” category. Thus, when step S312 is executed for the first time, the configuration unit 17 updates the provisional supervisory data by deleting the setting range area corresponding to the supervisory data configured in step S311 from the setting range areas contained in the provisional supervisory data initialized in step S303. In the second and subsequent execution of step S312, the configuration unit 17 updates the provisional supervisory data by deleting the setting range area corresponding to the supervisory data configured in previously-executed step S311 from the setting range areas contained in the provisional supervisory data stored in the supervisory database M3.

In step S313, the identification unit 14 determines the deviation between the provisional supervisory audio data indicated by the provisional supervisory data stored in the supervisory database M3 and the audio data indicated by each piece of the unprocessed data.

In step S314, the identification unit 14 identifies setting range data to be a target of the next label data setting operation based on the deviation determined in step S313.

In step S315, the identification unit 14 determines whether the deviation corresponding to the unprocessed data identified in step S314 is equal to or less than a preset threshold value. The deviation here is the index that a higher value of the index indicates a higher deviation. If the identification unit 14 determines that the deviation corresponding to the unprocessed data identified in step S314 is equal to or less than the preset threshold value (YES in step S315), the identification unit 14 determines that the label data setting operation is completed, and the processing proceeds to step S316. On the other hand, if the identification unit 14 determines that the deviation corresponding to the unprocessed data identified in step S314 is more than the preset threshold value (NO in step S315), the processing proceeds to step S307.

In step S316, the configuration unit 17 sets the label data indicating the “normal” category to every piece of unprocessed data. Then, the configuration unit 17 configures supervisory data with respect to the unprocessed data to which the label data indicating the “normal” category is set. In the present exemplary embodiment, since the initial value of the label data is set to every human body range area in step S303, the configuration unit 17 does not have to configure supervisory data again in step S316.

In step S317, the configuration unit 17 stores in the supervisory database M3 the supervisory data configured in step S316. The supervisory data stored in the supervisory database M3 at this point is determined as final supervisory data.

As described above, the processing according to the present exemplary embodiment enables the information processing server 10 to identify candidate data for the “noise” category even in the case where the basic data is audio data.

Further, an image of a setting range with a high deviation, a reproduction button, or the like is emphasized and displayed to enable the operator to recognize with ease which audio corresponds to a setting range with a high deviation so that the operator can focus with ease on a person to be tracked.

Further, the appearance such as the color or shape of the image or reproduction buttons is changed according to the label data setting state to visualize the label data setting state so that the operator can intuitively recognize the label data setting state.

While the information processing server 10 has been described as a single information processing apparatus in the first to fourth exemplary embodiments, the information processing apparatus can be a plurality of personal computers (PCs), server apparatuses, tablet apparatuses, or the like. In this case, CPUs of the respective information processing apparatuses included in the information processing server 10 cooperate to execute processing based on a program stored in a secondary storage device of each of the information processing apparatuses so that the functions illustrated in FIGS. 3 and 9, the processes illustrated in the flowcharts in FIGS. 5, 8, and 11, etc. are realized.

While various exemplary embodiments have been described in detail above, the present invention is not limited to the above-described specific exemplary embodiments. For example, the above-described exemplary embodiments can be combined as desired.

The above-described exemplary embodiments are capable of identifying data which is candidate data for a preset category, from a plurality of pieces of data even if an initial value of a category of each piece of data contained in the plurality of pieces of data is unknown.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-098163, filed May 17, 2017, which is hereby incorporated by reference herein in its entirety.

What is claimed is:

1. An information processing apparatus comprising:
a receiving unit configured to receive designation of a category with respect to data contained in a plurality of pieces of data;
a determination unit configured to determine a deviation which indicates a degree of deviance between the data contained in the plurality of pieces of data and a first category based on the data with respect to which the designation of the category is received by the receiving unit; and
an identification unit configured to identify, from the plurality of pieces of data based on the determined deviation, data to be candidate data of a second category different from the first category.

2. The information processing apparatus according to claim 1,
wherein the receiving unit receives designation of the first category with respect to data contained in the plurality of pieces of data, and
wherein the determination unit determines as the deviation a degree of deviance between the data with respect to which the designation of the first category is received and data contained in the plurality of pieces of data.

3. The information processing apparatus according to claim 1,
wherein the receiving unit receives designation of the second category with respect to data contained in the plurality of pieces of data, and
wherein the determination unit determines as the deviation a degree of deviance between the plurality of pieces of data excluding the data with respect to which the designation of the second category is received and data contained in the plurality of pieces of data.

4. The information processing apparatus according to claim 1, further comprising a display control unit configured to display the plurality of pieces of data on a display unit,
wherein the receiving unit receives designation of a category with respect to data contained in the plurality of pieces of data displayed on the display unit.

5. The information processing apparatus according to claim 4, wherein the receiving unit receives designation of a category with respect to each of the plurality of pieces of displayed data according to a click movement.

6. The information processing apparatus according to claim 4, wherein the reception unit receives designation of a category with respect to each of the plurality of pieces of displayed data according to a flick operation, the category corresponding to a type of the flick operation.

7. The information processing apparatus according to claim 4, wherein the display control unit displays together with the plurality of pieces of data a state of progress of the designation of the category with respect to the plurality of pieces of data.

8. The information processing apparatus according to claim 5, further comprising an acquisition unit configured to acquire a level of progress of a classification operation on the plurality of pieces of data based on the number of pieces of data identified by the identification unit and the number of pieces of data with respect to which the category is designated, among the pieces of identified data,
wherein the display control unit displays the level of progress as the state of progress.

9. The information processing apparatus according to claim 4, wherein the display control unit displays the identified data on the display unit.

10. The information processing apparatus according to claim 9, wherein the display control unit displays on the display unit the identified data in a display form according to the deviation corresponding to the identified data.

11. The information processing apparatus according to claim 4, wherein the display control unit displays on the display unit data similar to the identified data among the plurality of pieces of data.

12. The information processing apparatus according to claim 4, wherein the display control unit displays each of the plurality of pieces of data in a display form according to the category corresponding to the data.

13. The information processing apparatus according to claim 1, further comprising a setting unit configured to set data of the first category to data with respect to which no category is designated, among the plurality of pieces of data in a case where no data is identified as candidate data of the second category by the identification unit.

14. The information processing apparatus according to claim 1, wherein each of the plurality of pieces of data is an area of an object in a frame in a moving image.

15. The information processing apparatus according to claim 14, wherein the reception unit collectively receives designation of the category with respect to continuous data during a designated period among data of an area of the same object contained in the plurality of pieces of data.

16. The information processing apparatus according to claim 1, wherein each of the plurality of pieces of data is audio data.

17. The information processing apparatus according to claim 1, wherein the determination unit determines the deviation based on a feature amount of data of interest and a feature amount of data with respect to which designation of the first category is received.

18. The information processing apparatus according to claim 1, wherein the first category corresponds to normal, and the second category corresponds to noise.

19. An information processing method which is executed by an information processing apparatus, the method comprising:
receiving designation of a category with respect to data contained in a plurality of pieces of data;
determining a deviation which indicates a degree of deviance between the data contained in the plurality of pieces of data and a first category based on the data with respect to which the designation of the category is received; and
identifying, from the plurality of pieces of data based on the determined deviation data to be candidate data of a second category different from the first category.

20. A non-transitory computer readable storage medium storing instructions that, when executed, cause a computer to execute a process, the process comprising:
receiving designation of a category with respect to data contained in a plurality of pieces of data;
determining a deviation which indicates a degree of deviance between the data contained in the plurality of pieces of data and a first category based on the data with respect to which the designation of the category is received; and
identifying, from the plurality of pieces of data based on the determined deviation, data to be candidate data of a second category different from the first category.
